(19) United States
(12) Patent Application Publication
(10) Pub. No.: US 2026/0339500 A1
(43) Pub. Date: Oct. 29, 2026

(54) SYSTEMS AND METHODS FOR QUEUE BASED AND WORKFLOW DRIVEN RECORDS MANAGEMENT

(71) Applicant: CENTRALSQUARE TECHNOLOGIES, LLC, Lake Mary, FL (US)

(72) Inventors: Kevin Cosentino, Wilmington, NC (US); Laura Wilkes, Lampasas, TX (US); James Patrick Jones, JR., Huntley, IL (US)

(73) Assignee: CENTRALSQUARE TECHNOLOGIES, LLC, Lake Mary, FL (US)

(21) Appl. No.: 19/661,318

(22) Filed: Apr. 28, 2026

Related U.S. Application Data
(60) Provisional application No. 63/796,596, filed on Apr. 29, 2025.

(51) Int. Cl. G06F 3/04847; G06F 3/0482; G06F 16/335

(52) U.S. Cl. CPC G06F 3/04847; G06F 3/0482; G06F 16/335

(57) ABSTRACT

Systems and methods for managing records using a queue-based workflow interface are disclosed. In some embodiments, a system includes a server configured to present a browser-based user interface comprising a persistent title bar, multiple queues listing records associated with workflow statuses, and a slide-out menu providing access to record management functions. Users may select records directly from queues, view and modify records through a data entry interface, and save changes while maintaining workflow associations. Queue-specific action menus may support operations such as filtering, grouping, exporting, or deleting records, and records may transition automatically between queues as workflow steps are completed. Additional embodiments support configurable and non-linear workflows, dynamic validation, master record association, audit tracking, and offline data entry with synchronization. The disclosed approach provides a flexible framework for managing records across workflow states.

### CROSS REFERENCE TO RELATED APPLICATIONS

The present application claims priority to United States Provisional Application No. 63/796,596, filed on Apr. 29, 2025, the contents of which are incorporated herein by reference.

### TECHNICAL FIELD

The present disclosure relates generally to the field of computer-implemented records management systems, and more particularly to systems and methods for managing digital records using queue-based user interfaces and configurable workflow architectures.

### BACKGROUND

As organizations increasingly rely on digital systems to create, manage, and store records, the volume, complexity, and interdependence of those records have grown substantially. Records are often generated across multiple departments, users, and devices, and may require review, approval, correction, or other processing before reaching a completed state. Managing these records efficiently while maintaining accuracy, traceability, and visibility into their status remains a persistent technical challenge across many industries, including public safety, healthcare, finance, and enterprise operations.

Traditional records management systems frequently rely on rigid, form-centric or document-centric interfaces that require users to navigate through multiple screens, menus, or file hierarchies to locate and update records. Workflow logic in such systems is often linear and inflexible, making it difficult to accommodate real-world processes that involve branching, rework, or reassignment. As a result, users may struggle to understand the current status of records, identify which items require action, or efficiently move records through their required processing stages.

Another challenge arises from the fragmented handling of workflow actions and record editing. In many existing systems, actions such as filtering, exporting, approving, or reassigning records are performed in separate administrative tools or screens, disconnected from the primary record view. This fragmentation can lead to inefficiencies, increased error rates, and delayed processing, particularly when users must manually track record status or perform repetitive operations across large numbers of records.

Data quality and consistency further complicate record management. Validation of record data is often deferred until late in a workflow, resulting in records being routed for review or approval before required information is complete or compliant. Additionally, systems that lack robust mechanisms for identifying and associating shared entities—such as people, locations, or assets—may create duplicate or inconsistent records, reducing the reliability of the overall dataset and increasing downstream correction efforts.

These challenges are exacerbated in environments where users operate across different devices or under varying network conditions. For example, users working remotely or in the field may experience limited connectivity, yet still need to create or update records in a timely manner. Conventional systems may provide limited or no support for offline operation, further constraining usability and productivity.

Accordingly, there is a need for improved systems and methods that provide flexible, intuitive, and scalable mechanisms for managing records across workflow states. Such solutions should enable users to interact with records through unified interfaces that clearly reflect workflow status, support dynamic validation and data consistency, and accommodate non-linear workflows. As described herein, the disclosed embodiments address these challenges by providing a queue-centric records management framework that integrates record editing, workflow control, and auditability within a cohesive technical architecture.

### SUMMARY

The disclosed embodiments include computing systems and computer-implemented methods for managing records using queue-based user interfaces and configurable workflow architectures. In some embodiments, a computing system includes at least one processor and a memory storing executable instructions that, when executed, cause the system to present a browser-based user interface comprising a persistent title bar, a plurality of queues associated with workflow states, and a slide-out menu providing access to record management functions. Records may be selected directly from queues, displayed in a data entry interface, modified through user input, and saved while maintaining an association with a corresponding workflow status.

In some embodiments, queues may include queue-specific action menus that enable operations such as viewing, filtering, grouping, exporting, or deleting records, including bulk operations on multiple selected records. Records may transition automatically between queues as workflow steps are completed, and workflow behavior may be configurable and non-linear, allowing transitions based on actions such as approval, rejection, recall, or reassignment. The system may further support dynamic validation of record data, master record association, workflow audit tracking, and offline data entry with subsequent synchronization.

In some embodiments, the system may determine queue membership based on one or more record attributes, including workflow status, assignment, role-based permissions, or other configurable conditions. When a record is updated or a workflow action is performed, the system may update queue membership and record visibility so that users are presented with current information reflecting the record’s state. Different record types may be managed using a shared interface and workflow framework, while still supporting record-type-specific fields, templates, and validation rules. This approach may allow consistent interaction across record types while accommodating differing operational requirements.

In some embodiments, the system may be configurable for use by different departments, agencies, or teams, each having distinct workflows, permissions, and queue configurations. Users may interact with the same underlying system while viewing different queues or available actions based on their roles. By organizing records around workflow states and enabling actions directly from queue views, the disclosed embodiments may reduce manual coordination, improve visibility into work status, and support efficient record processing across diverse operational contexts.

Throughout this disclosure, the phrase “disclosed embodiments” refers to examples of inventive concepts, implementations, or combinations of features described herein. Various disclosed embodiments may include different features or combinations of features, and no inference should be drawn that any particular feature is required in all embodiments unless explicitly stated.

It is to be understood that both the foregoing Summary and the following Detailed Description are exemplary and explanatory only and are not restrictive of the disclosed embodiments, as claimed.

### BRIEF DESCRIPTION OF FIGURES

FIG. 1A illustrates an exemplary environment illustrating problems addressed by the present disclosure is shown.

FIG. 1B illustrates an exemplary environment illustrating a solution provided by the present disclosure is shown, consistent with disclosed embodiments.

FIG. 2A illustrates an exemplary user interface for a records system, consistent with disclosed embodiments.

FIG. 2B illustrates an exemplary user interface for a title bar, consistent with disclosed embodiments.

FIG. 2C illustrates an exemplary user interface for a slide-out menu, consistent with disclosed embodiments.

FIG. 3A illustrates an exemplary user interface for an In Progress queue, consistent with disclosed embodiments.

FIG. 3B illustrates an exemplary user interface for an Approval queue, consistent with disclosed embodiments.

FIG. 4 illustrates an exemplary user interface for a Quick View screen, consistent with disclosed embodiments.

FIG. 5A illustrates an exemplary user interface for a My Reports queue, consistent with disclosed embodiments.

FIG. 5B illustrates an exemplary user interface for another In Progress queue, consistent with disclosed embodiments.

FIG. 6 illustrates an exemplary user interface for a Report Administration queue, consistent with disclosed embodiments.

FIGS. 7A and 7B illustrate exemplary user interfaces for a Queue Actions menu, consistent with disclosed embodiments.

FIG. 8 illustrates an exemplary user interface for a workflow audit, consistent with disclosed embodiments.

FIG. 9 illustrates an exemplary user interface for a Confirm Delete user interface, consistent with disclosed embodiments.

FIGS. 10A-10D illustrate exemplary user interfaces for filtering menus, consistent with disclosed embodiments.

FIG. 11 illustrates an exemplary user interface for a Queue Manager menu, consistent with disclosed embodiments.

FIG. 12 illustrates an exemplary user interface for a data entry screen, consistent with disclosed embodiments.

FIG. 13 illustrates an exemplary user interface for a section form screen, consistent with disclosed embodiments.

FIG. 14A illustrates an exemplary user interface for a Create New record menu, consistent with disclosed embodiments.

FIG. 14B illustrates an exemplary user interface for a blank data entry page, consistent with disclosed embodiments.

FIG. 14C illustrates an exemplary user interface for a master record match message, consistent with some disclosed embodiments.

FIG. 14D illustrates an exemplary user interface for a display validation error consistent with disclosed embodiments.

FIG. 14E illustrates an exemplary user interface for a Create Summary form, consistent with disclosed embodiments.

FIG. 15 illustrates an exemplary user interface for a Recent Information screen, consistent with disclosed embodiments.

FIG. 16 illustrates an exemplary user interface for a Send Report form, consistent with disclosed embodiments.

FIG. 17A illustrates an exemplary user interface for a validations screen, consistent with disclosed embodiments.

FIGS. 17B and 17C illustrate exemplary user interfaces for validation error notifications, consistent with disclosed embodiments.

FIG. 18 illustrates an exemplary user interface for a case management user interface, consistent with disclosed embodiments.

FIG. 19 illustrates an exemplary user interface for a case navigation menu, consistent with disclosed embodiments.

FIG. 20 illustrates an exemplary user interface for a Case Details user interface, consistent with disclosed embodiments.

FIG. 21A illustrates an exemplary user interface for a Case Overview user interface, consistent with disclosed embodiments.

FIG. 21B illustrates an exemplary user interface for a drop-down menu, consistent with disclosed embodiments.

FIG. 22 illustrates an exemplary user interface for an Associated Cases user interface, consistent with disclosed embodiments.

FIG. 23 illustrates an exemplary process for an operation of the system, consistent with disclosed embodiments.

FIG. 24 illustrates an exemplary diagram of an exemplary system environment, consistent with disclosed embodiments.

FIG. 25 illustrates an exemplary process for operations that are performed by a records management system, consistent with disclosed embodiments.

FIG. 26 illustrates an exemplary flowchart for additional operations in the records management system, consistent with disclosed embodiments.

FIG. 27 illustrates an exemplary flowchart for operations associated with queue-centric record interaction and workflow progression in a records management system, consistent with disclosed embodiments.

FIG. 28 illustrates an exemplary flowchart for additional operations in the records management system, consistent with disclosed embodiments.

FIG. 29 illustrates an exemplary flowchart for operations related to configurable workflows and workflow-based record management operations in the records management system, consistent with disclosed embodiments.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be implemented and that changes may be made without departing from the scope of the disclosed embodiments. For example, particular user interfaces and user interface elements may be configured differently, including in different positions, arrangements, and appearances. Phrases that tend to indicate an order of events, such as “before,” “prior to,” then,” “after,” and the like are not intended to be limiting. Similarly, additional steps may be added, or steps may be removed, without departing from the envisioned embodiments. Thus, the materials, methods, and examples are illustrative only and are not intended to be necessarily limited.

A system may include a records management system (RMS) and a field-based reporting (FBR) system that operate on the disclosed system environment. The system may be presented in a browser-based user interface on the devices 2401. The system may accept user inputs in the form of manually entered information, file uploads, downloads from other sources, and other inputs. The system may automatically save the entered information and other inputs to the system onto the devices 2401 or the servers 2403. The system may create reports and other documents based on the inputs. The system may output the created documents in a variety of forms including Portable Document Format (PDF) or other widely accepted file formats. The system may provide the ability to add comments to a created document. The system may conform to standards and policies set by the Federal Bureau of Investigation (FBI) Criminal Justice Information System (CJIS), such as a password policy.

The system may be configurable to allow a user or department to adjust or customize features of the system. The system may allow data entry customization including but not limited to customizing data entry templates, layouts, fields, labels, required sections, required fields, custom fields, default values, and code table values. The system may allow workflow customization including but not limited to customizing workflows for each type of report and each data entry template. The system may function without requiring a static, linear workflow. The system may allow queue customization including but not limited to customizing the queues on landing pages to meet individual or department preferences or needs.

The system may provide a way to select or link a new entry from existing names, organizations, addresses, properties, and vehicles in a master database, or add new records to a master database. The master database may be a database of all other records that share a data entry, such as a name, organization, location, vehicle, or other data.

The system may provide for intelligent data entry. The intelligent data entry may populate reports or other fields with recently entered information such as people, events, properties, or vehicle, or other information. As a user enters data, the system may provide validation of entered information based on federal and agency defined validations, state-specific uniform crime reporting/national incident-based reporting systems (UCR/NIBRS), or other validations. The system may dynamically adjust the fields available for data entry based on previously entered data. The dynamic data entry adjustments may be based on state reporting rules or other rules. The system may include offline functionality and permit data entry when no connection to the internet or a server is available.

The system may include a plurality of functional modules that may be added to or removed from the system to tailor operation to the needs of a particular user, department, or organization. Each module may correspond to a specific type of record, operational activity, or functional domain, and may define how related records are created, edited, validated, stored, and advanced through workflows. For example, a Case module may manage overarching case records that group related incidents, while an Incident module may capture details of specific events associated with a case. In practice, a single incident record created in the Incident module may automatically be associated with a corresponding case managed by the Case module, allowing users to view related records together.

Additional modules may support specialized operational needs and may interact with one another as records progress through workflows. For instance, an Arrest and Juvenile Custody module may generate records that are linked to incident records and later referenced by a Case Management module. A Field Interview module may collect information in the field that is later incorporated into an Incident or Case record, while a Call for Service module may initiate the creation of related records based on dispatch activity. Modules such as Citation, Crash, Impound, Warrant, Civil, and Other Event may similarly produce records that are associated with cases or incidents and managed collectively through the system.

Other modules may provide shared or cross-cutting functionality. For example, a Master Records module may store shared entities such as persons, locations, or vehicles that are referenced by records created in multiple modules. A Property and Evidence module may track items associated with incidents or arrests, while a Digital Evidence Management System or Imaging module may store and link digital media to corresponding records. Modules such as State Reporting, Reporting, Expungement, Restrictions, and National Crime Information Center may interact with records across multiple modules to enforce compliance, generate reports, restrict access, or integrate with external systems. In some embodiments, the system may also include state-specific modules, such as CHP 180, FBI Workforce Count, Use of Force, or other jurisdiction-specific modules, which may apply additional rules or workflows to records created in other modules.

The system may further include a set of administrative functions that support configuration, governance, and ongoing management of system operation. These administrative functions may enable authorized users to define how modules interact, how records are structured, and how workflows operate across the system. For example, a Workflow Designer may define the states and transitions that apply to records created by different modules, while Case Management Administration may configure how cases aggregate incidents, arrests, or other related records. Changes made through these administrative tools may affect how records created in one module appear or behave when accessed through another module.

Additional administrative functions may support data consistency and system customization. For instance, a Data Entry Designer may define the layout, required fields, and conditional behavior used across multiple modules, while Codes Management and Configuration Management may provide shared values and rules referenced by those modules. Masters Management may control how shared master records are created and maintained, ensuring that records from different modules reference common entities consistently. Administrative tools such as Role Management, User Management, and Restriction Management may determine which users can access particular modules, records, or workflow actions, thereby coordinating security and permissions across the system.

Other administrative functions may support auditing, output, and system extensibility. An Audit Log may capture actions performed across modules for traceability, while Output Designer and Form Letter Designer may generate documents or reports based on records originating from multiple modules. Property and Evidence Configuration, Fees Management, and Citation Book Management may define rules or resources used by operational modules during record creation or processing. Together, these administrative functions may allow the system to be configured and adapted over time while preserving consistent interaction between modules and maintaining centralized control over system behavior.

The disclosed systems and methods may be implemented on a network, where a user operates a computer, smart phone, or other device connected to the network and in communication with a server. The arrangement of functionalities and/or components set forth in the figures is not intended to limit the disclosed embodiments in any way, as the functionalities and/or components used in the disclosed methods and systems may vary.

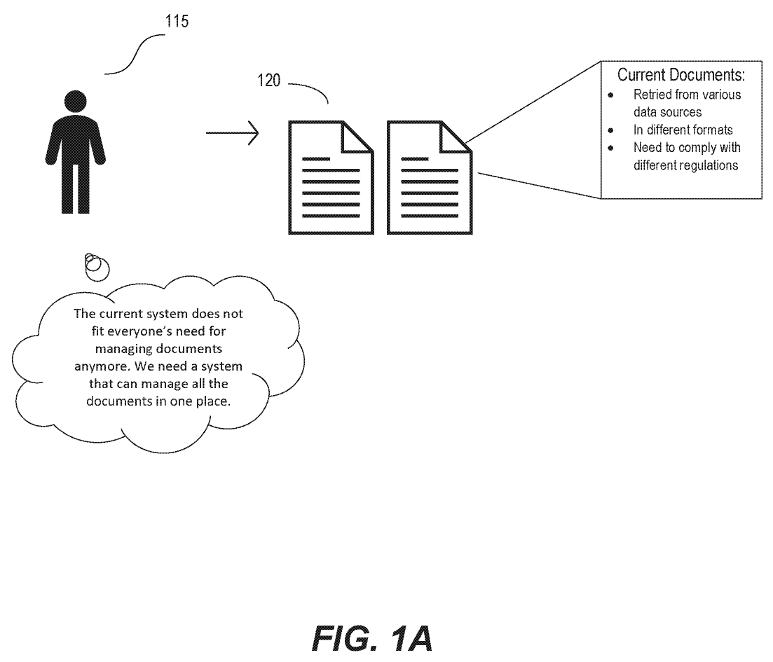

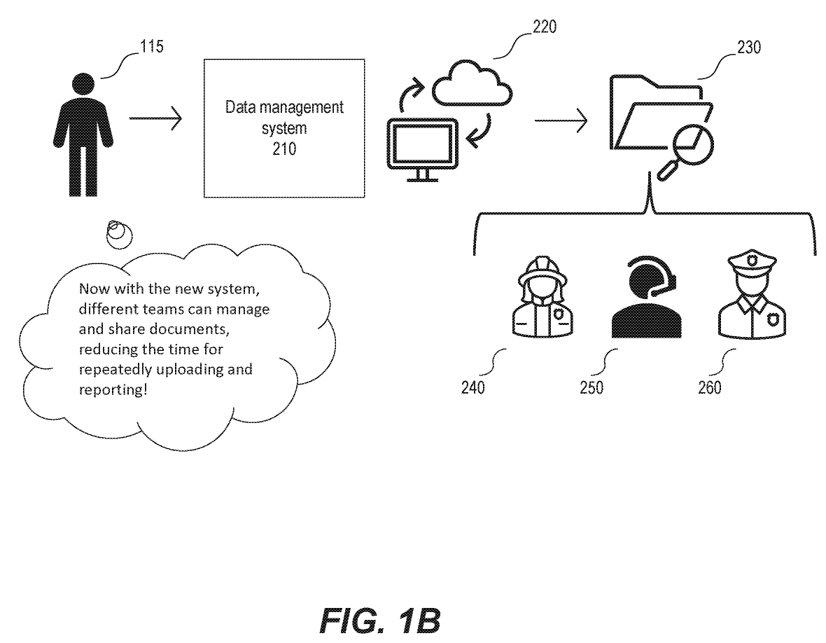

Referring to FIG. 1A, an exemplary environment illustrating problems addressed by the present disclosure is shown. The environment includes a user 115 interacting with a conventional document or records management environment in which documents 120 are retrieved from multiple data sources. In existing systems, documents may originate from disparate systems, be stored in different formats, and be subject to different regulatory or organizational requirements. As illustrated, user 115 may perceive that the current system does not fit the needs of all users or teams and may lack a unified way to manage documents in one place.

In particular, conventional systems often require documents to be repeatedly uploaded, reformatted, or reconciled across separate tools or platforms. Documents 120 may be unorganized, inconsistently structured, and difficult to share across departments, resulting in duplicated effort and increased risk of error or non-compliance. As shown in FIG. 1, user 115 expresses frustration because existing approaches are fragmented, inefficient, and poorly suited to collaborative, multi-team document management. From a system perspective, these conditions may increase operational overhead, delay processing, and reduce visibility into document status and ownership.

Referring to FIG. 1A, an exemplary environment illustrating a solution provided by the present disclosure is shown. The environment includes user 115 interacting with a data management system 210 that is connected to a cloud server 220. Data management system 210 may provide a unified platform for organizing, managing, and sharing documents across multiple users and teams. Unlike the environment shown in FIG. 1, documents 230 may be centrally managed and presented in an organized manner that supports collaboration and controlled access.

As illustrated, documents 230 managed by system 210 may be accessed, uploaded, or shared by different roles or teams, such as firefighters 240, dispatchers 250, and law enforcement personnel 260. Each team may interact with the same set of documents according to its responsibilities, without requiring redundant uploads or manual reconciliation across systems. In this environment, user 115 now recognizes that the new system enables different teams to manage and share documents more efficiently, reducing the time and effort associated with repeated reporting and document handling.

By centralizing document management within data management system 210 and leveraging cloud server 220 for storage and coordination, the disclosed approach may improve consistency, reduce duplication, and enhance collaboration across organizational boundaries. In contrast to FIG. 1A, the environment shown in FIG. 1B demonstrates how a unified, system-driven solution may address limitations of conventional document management approaches and support scalable, multi-user operation.

In some embodiments, data management system 210 may operate as a centralized platform that organizes, tracks, and shares documents across multiple teams and operational roles. System 210 may receive documents from different sources, store them in a common environment supported by cloud server 220, and associate those documents with relevant workflows or activities. Rather than requiring each team to maintain separate copies or systems, system 210 may provide a shared, authoritative view of documents while controlling how and when they are accessed or updated. This centralized approach may reduce duplication, improve consistency, and allow users to quickly locate the information they need.

For example, in an emergency response scenario, firefighters 240, dispatchers 250, and law enforcement personnel 260 may each interact with the same set of documents through system 210, but for different purposes. Dispatchers may upload or update incident information, firefighters may access building plans or response notes while in the field, and law enforcement may review reports or add supplemental documentation. System 210 may coordinate these interactions so that updates made by one team are available to others in a timely manner, without requiring repeated uploads or manual coordination. In this way, system 210 may support collaboration across teams while maintaining organized, up-to-date documents that reflect ongoing operations.

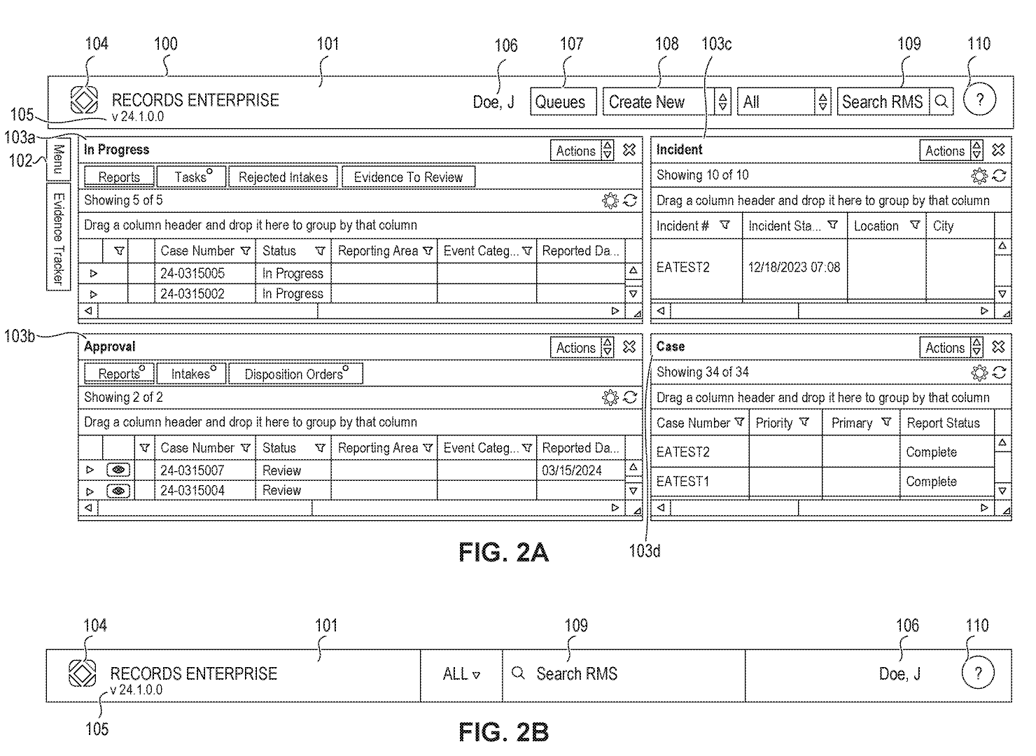

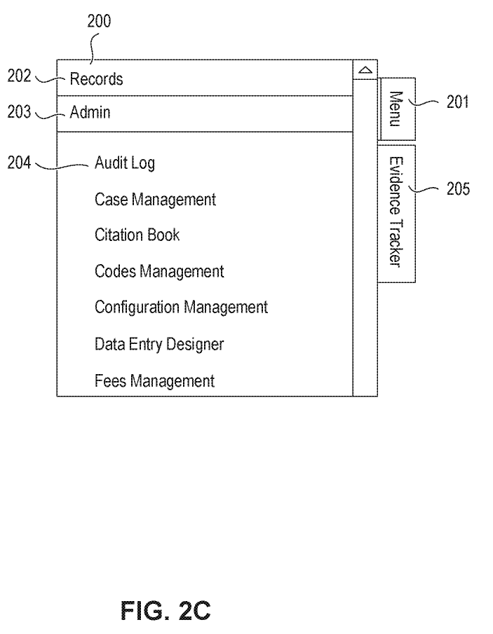

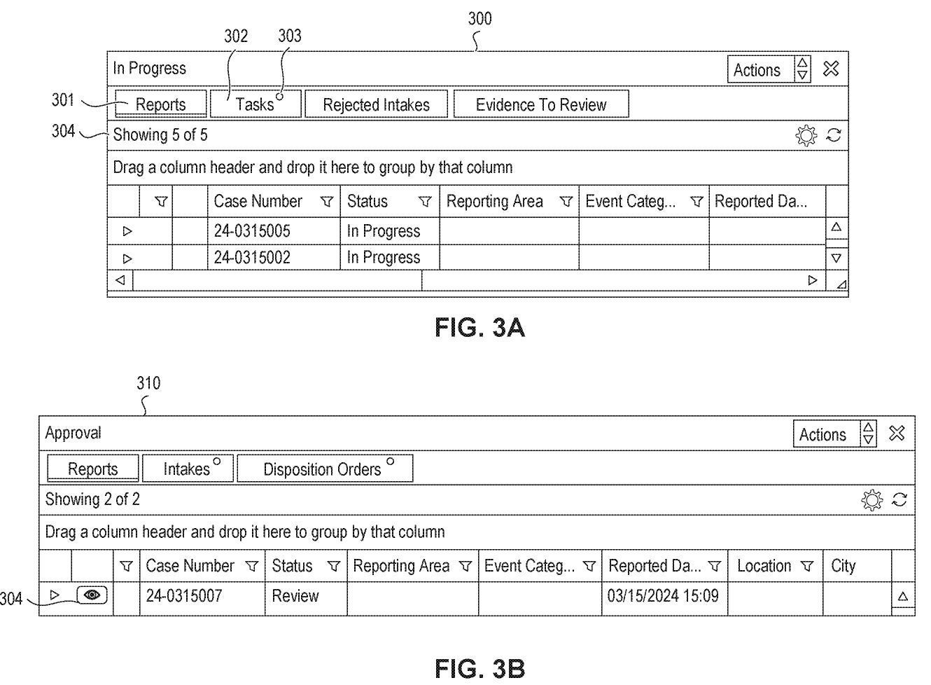

FIG. 2A is an illustration of an exemplary user interface for a records system. The system may include a user interface such as an exemplary user interface 100 shown in FIG. 2A. The user interface 100 may include features such as a title bar 101, a slide-out menu button 102, and queues 103a-d. Title bar 101 may be persistent across all screens of user interface 100 and may contain the same or different user interface elements on each screen. For example, as shown in FIG. 2B, title bar 101 may include only home button 104, version number 105, identifier 106, and search field 109 in some user interface screens. The slide-out menu button 102 may reveal a slide-out menu (such as the slide-out menu illustrated in FIG. 2C) when the user selects the slide-out menu button 102. The queues 103a-d may be the various queues depicted in the various figures, for example an In Progress queue such as the one depicted in FIG. 3A. User interface 100 may include a home button 104 that returns a user to a default screen such as a home or landing page. User interface 100 may include an identifier, such as a version number 105, of the software application displaying the user interface. User interface 100 may include an identifier, such as user identifier 106, to identify the user of the interface. The user identifier 106 may be a button that allows the user to access account control actions such as sign out, sign in, change password, set user pin, or set electronic signature. User interface 100 may include a queue button 107 to allow a user to manage queues. User interface 100 may include a create new button 108 to allow a user to create a new record. User interface 100 may include a search field 109 to allow the user to search the system. User interface 100 may include a help button 110 to allow the user to access a help page. A title bar 101 may include user identifier 106, queue button 107, create new button 108, search field 109, and help button 110, or they may be located in other locations in user interface 100.

FIG. 2C is an illustration of an exemplary slide-out menu 200. Slide out menu 200 may be revealed when a slide-out menu button 201 is selected by the user. Records 202 and administrative functions 203 displayed in slide-out menu 200 may be configurable by the user, department, or system provider. The available administrative functions may vary based on a user’s permissions.

The system may provide an internet-based user interface that allows for access from any location or device using a supported internet browser. The system may be accessed exclusively through an application interface, through an application interface and an internet interface, or exclusively through an internet interface. There may be features of the system that are only accessible to a user in one of the application or internet interface. Selecting a listed administrative function, such as an audit log 204, from the list of administrative functions may bring a user to a new interface screen corresponding to that system feature. Slide-out menu 200 may also include other system features, which are accessible when a user selects other side buttons such as an Evidence Tracker button 205 (that may open an evidence tracker user interface if selected by a user). Other slide-out menu lists may include Property and Evidence, Expungement, Image Queue, Holding Facility, or other system features.

FIG. 3A is an illustration of an exemplary In Progress queue user interface. The user interface may include a variety of queues through the In Progress queue user interface. The system may use queues to present records to the user. Queues may include summary queues that display summaries of a record type. Summary queues may include Case, Incident, Arrest, Citation, Crash, Field Interview, Holding Facility, License and Permit, Call for Service, Other Event, Impound Vehicle, CHP 180, F.B.I. Workforce Count, Use of Force, Warrant, Civil, or other queues. Each summary queue may list a summary for each record of the corresponding type that has completed its workflow.

Queues may also include workflow queues that display records in the user’s workflow. Workflow queues may include In Progress, Approval, My Reports, Report Administration, or other queues. The system may enable certain queues by default or allow a user or department to control what queues are displayed on a home or landing page. The system may restrict access to certain queues based on the access level of the user. The system may include a case queue that displays all the cases created by a user.

With further reference to FIG. 3A, when a Reports tab 301 is selected, the In Progress queue may list records in the system created by the user with certain statuses, including In Progress, Rejected, Recalled, or other statuses. When selected, Reports tab 301 may be highlighted as shown or otherwise marked. The system may mark tabs such as Reports tab 301 or the Tasks tab 302 with a notification icon 303 to indicate that there are items in that tab. When selected, the Tasks tab 302 may display tasks created for the record. Queues such as the In Progress queue may contain a queue counter 304 that indicates the number of reports currently in that queue. The system may limit the number of reports displayed in a queue unless the user scrolls down, in order to optimize speed and performance of the user interface. For example, the system may initially only display the first 50 reports in the queue, and may display the remaining reports (up to the number listed in the queue counter) when the user scrolls down.

The user interface may also include an exemplary Approval queue 310 user interface, as shown in FIG. 3B. Approval queue 310 may display reports that are awaiting approval, and provide a quick view button 311 for each report in the queue. Quick View button 311 may allow a user to quickly view each report in a quick view screen. Quick view button 311 may eliminate the need to open the report in a different screen such as a data entry screen.

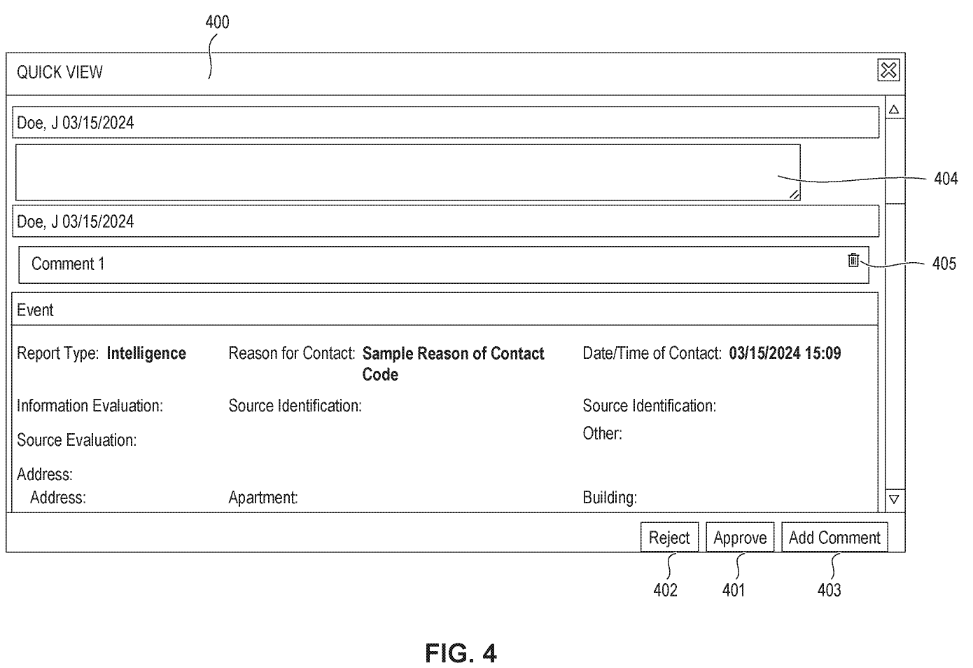

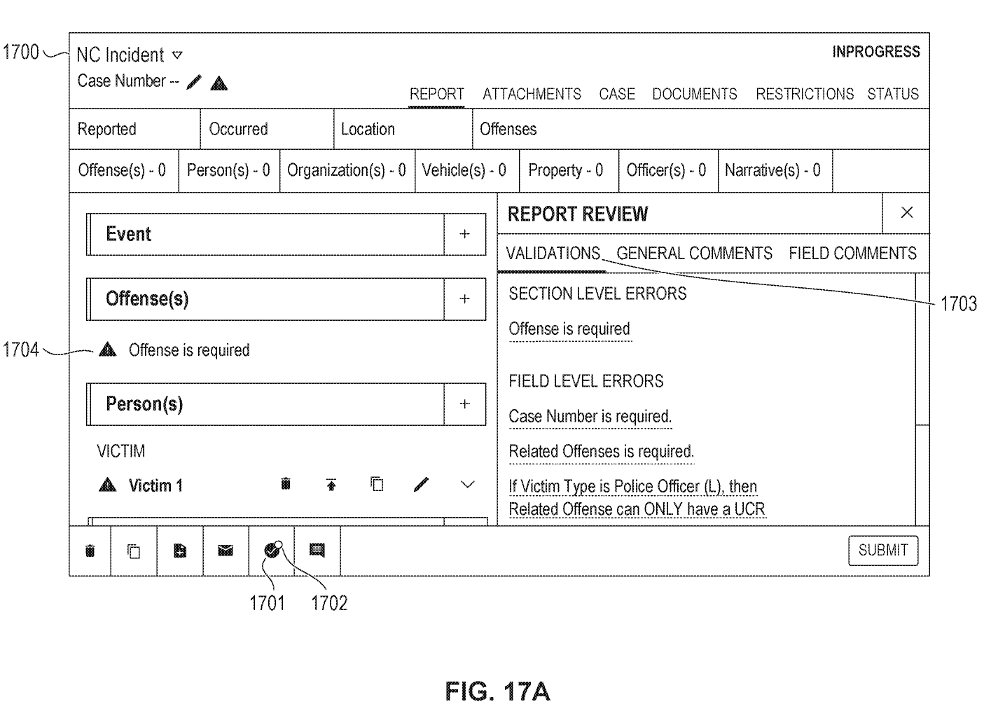

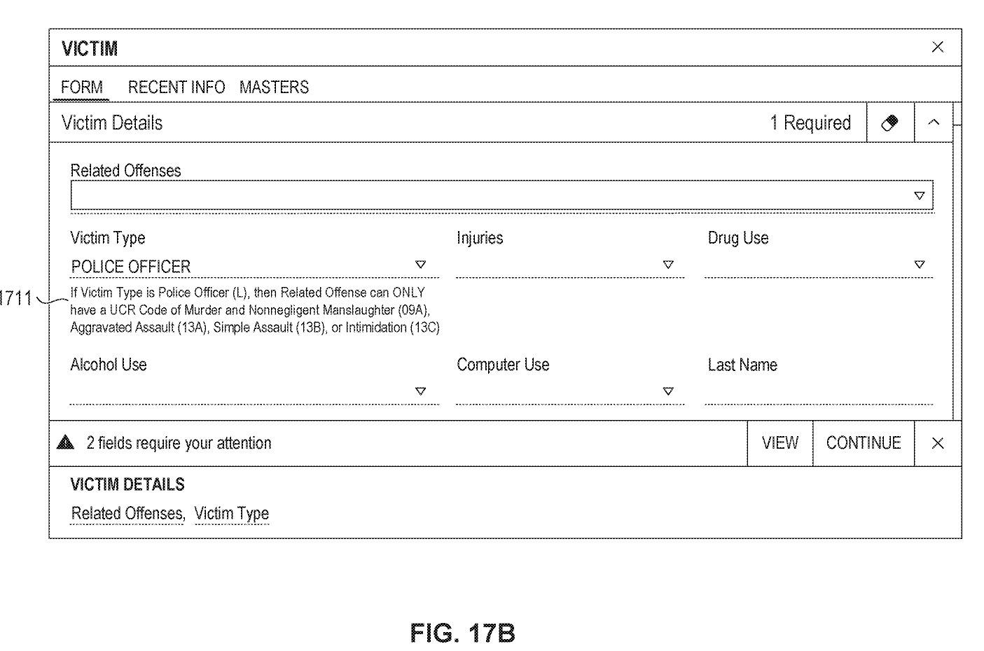

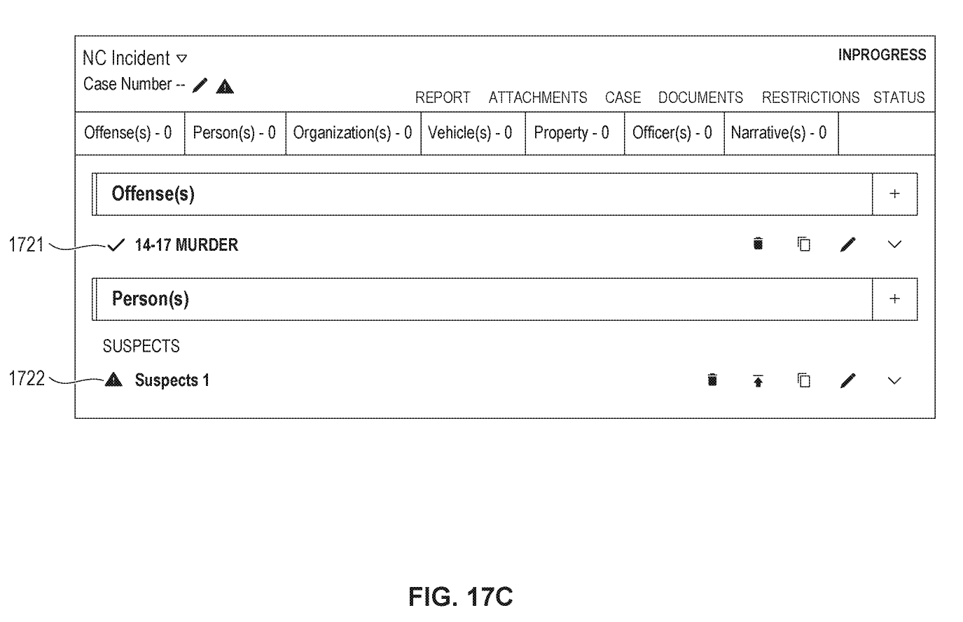

FIG. 4 shows an exemplary quick view screen 400. Quick view screen 400 may include an approve button 401 and a reject button 402 to approve or reject each report. The system may also include an add comment button 403 to allow a user to add a comment to a report in a comment field 404 without approving or denying the report. Reports shown in quick view screen 400 may be shown in read-only mode. Quick view screen 400 may include a delete button 405 to delete a comment. Approving or rejecting a report through quick view screen 400 may skip other steps, including validation steps (as described further with respect to FIGS. 17A-17B).

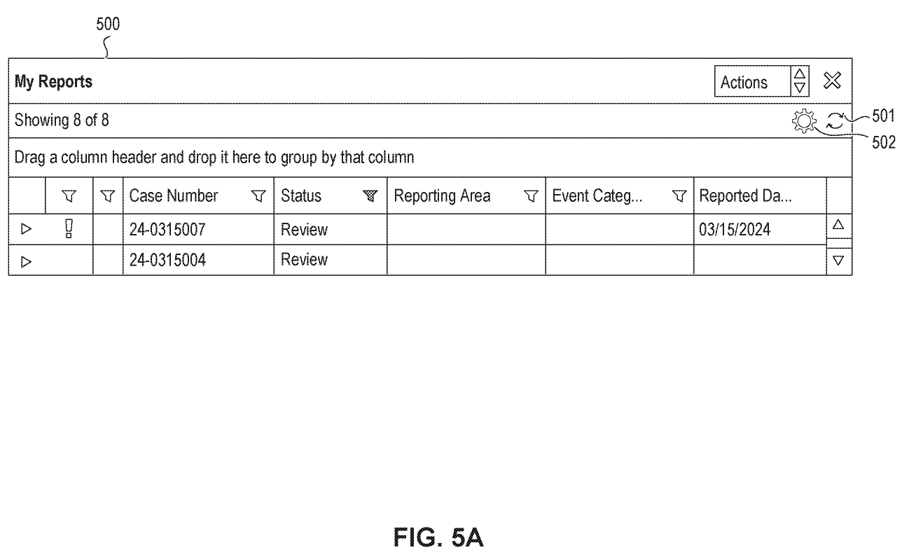

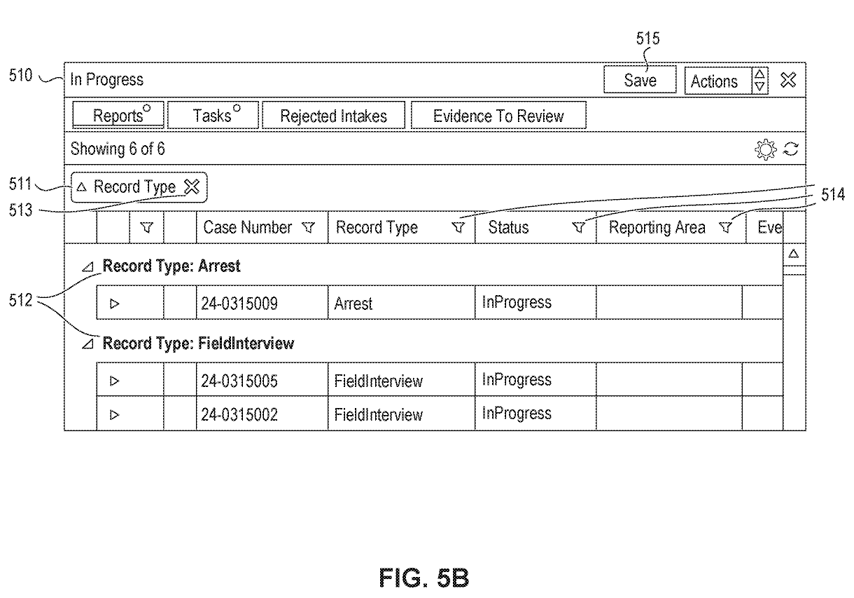

The user interface may also include a My Reports queue 500 as shown in FIG. 5A. The My Reports queue 500 may show all reports created by the current user. Queues may include a refresh button 501 that refreshes an individual queue. Queues may also include a customization button 502 that allows a user to group, sort, or filter records, or move, add, or remove columns in a queue.

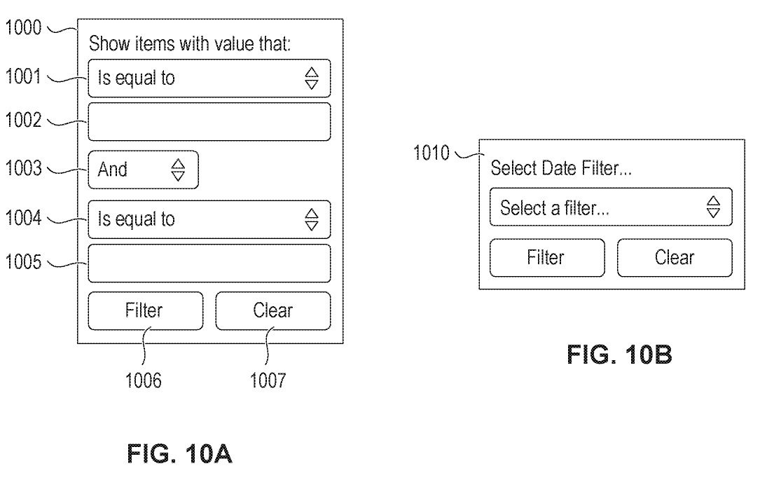

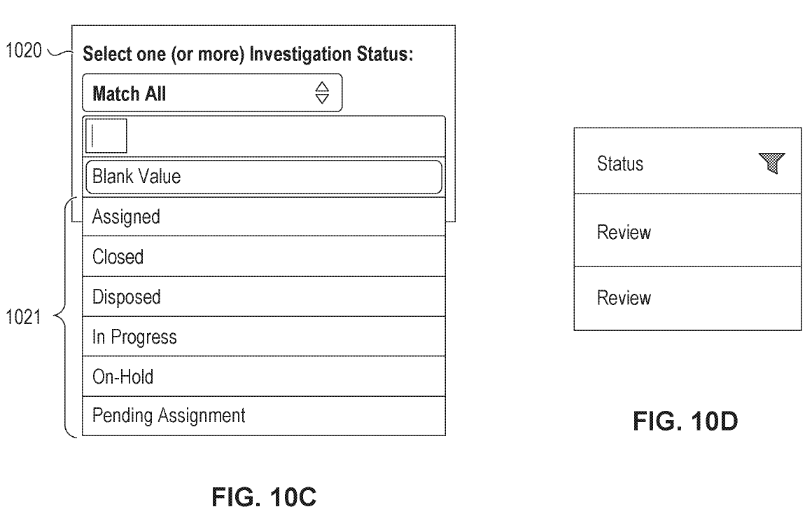

FIG. 5B shows an exemplary user interface for an In Progress queue 510 with records grouped by the selected column. In this example, the records are grouped by record type, as shown by grouping indicator 511. However, records could be grouped by a different grouping indicator 511 such as a status grouping indicator or a reporting area grouping indicator. The In Progress queue 510 may show the records in the queue grouped based on their record types 512, such as arrest or field interview. A queue with grouped records may include a button 513 to remove the grouping from the queue. The system may also allow the user to filter records in the various queues using filter buttons 514 (as describe further with respect to FIGS. 10A-10D). The system may allow a user to change the title of a queue, add or remove the queue to the home or landing page, or to resize the queue window. Queues that have been customized may include save button 515 to save the customization settings.

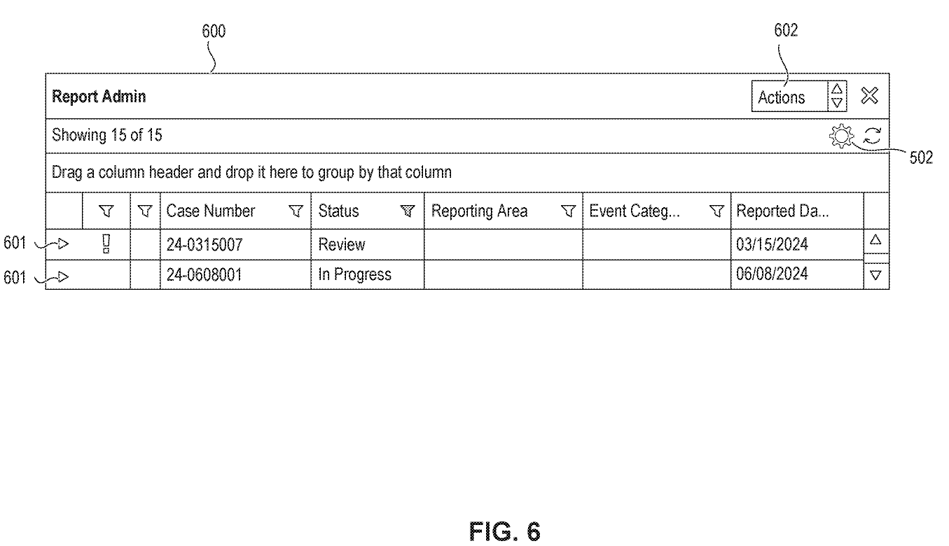

The user interface may also include a Report Admin (report administration) queue as shown in exemplary FIG. 6. The Report Admin queue 600 may display all reports, or all reports that the user has permission to access. The various queue user interfaces may include an arrow button 601 that shows various details about a report including a workflow audit (discussed below). The various queue user interfaces may include an Actions button 602 that opens a Queue Actions menu.

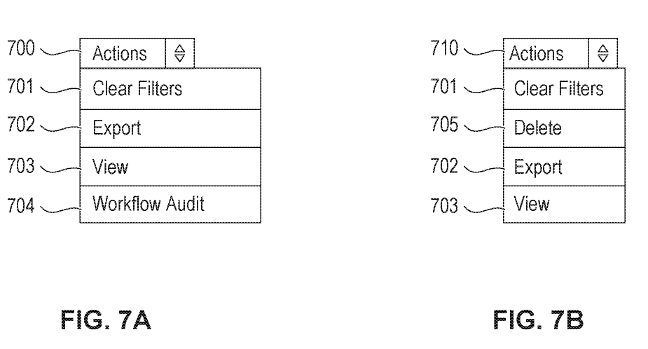

FIGS. 7A and 7B respectively illustrate exemplary Queue Action menus 700 and 701. The Queue Actions menus 700 and 710 may include different options based on the type of queue. For example, Clear Filters button 701, Export button 702, and View button 703 may be available in all queues, but Workflow Audit button 704 and Delete button 705 may be available only in queues where the user is permitted to perform such an action, or in queues where the system may perform such an action. Other possible actions include but are not limited to create new report. When the user selects the Clear Filters button 701, the system may remove any previously applied filters from the queue. When the user selects the Export button 702, the system may export the reports in the queue to an Excel spreadsheet or other file. When the View button 703 is selected, the system may open the selected reports in a new screen. When the Workflow Audit button 704 is selected by the user, the user may view where and when an individual report was at each specific step in its configured workflow. When either arrow button 601 in FIG. 6 or Workflow Audit button 704 in FIG. 7A is selected by a user, the system may display a workflow audit user interface.

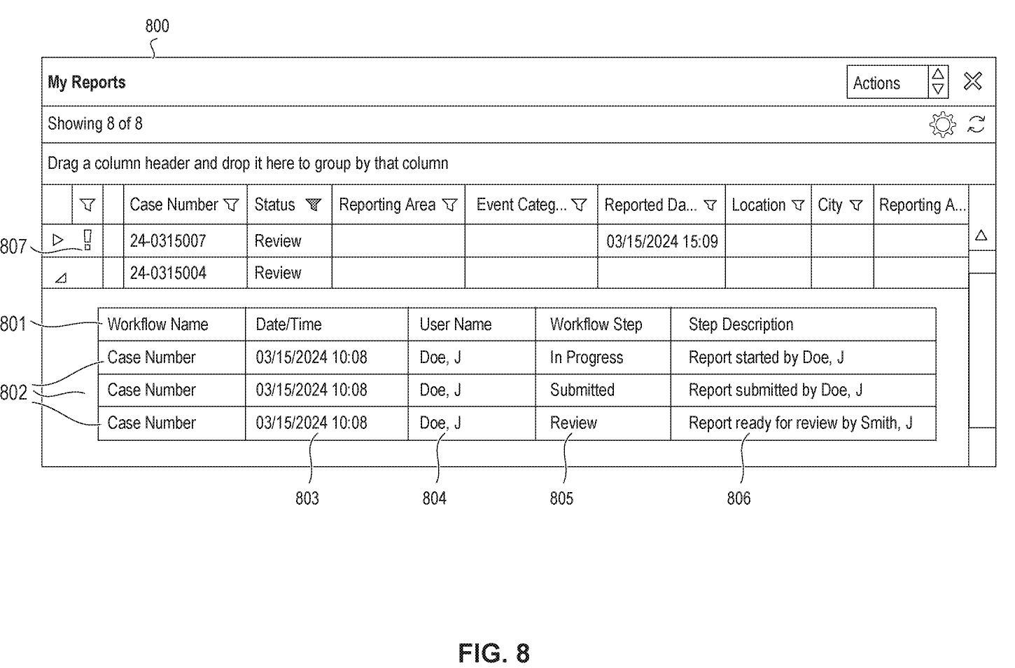

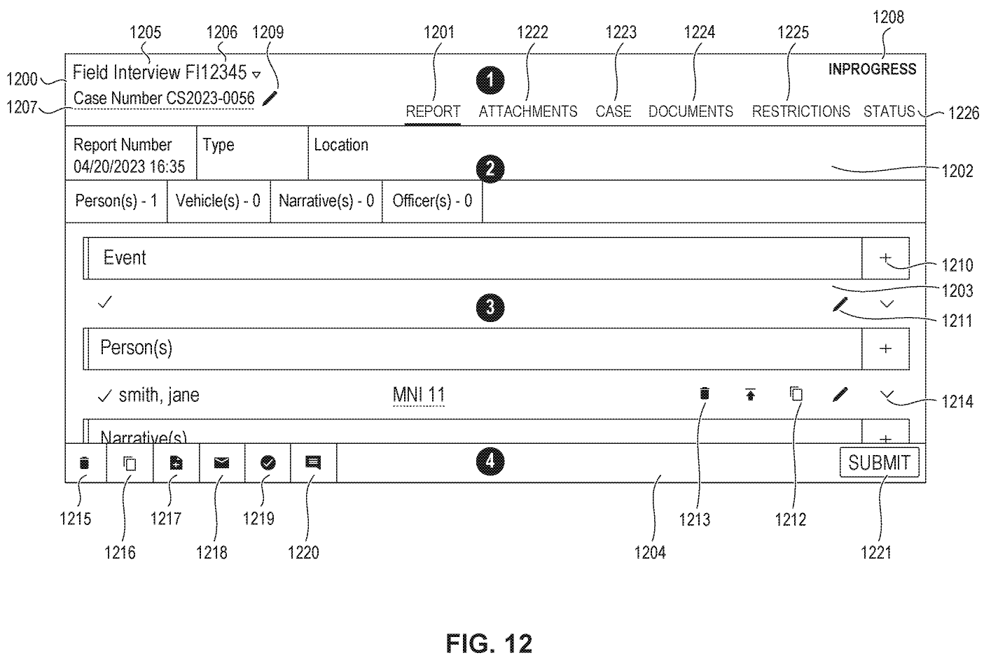

FIG. 8 shows an exemplary workflow audit user interface 800 that may include a workflow name 801, a list of workflow steps 802, dates and times 803 for each workflow step, a username 804 or another identifier for the user who completed the workflow step, the status of each workflow step 805, and a description 806 of each workflow step. Workflow steps 802 may be ordered based on the order in which they were completed or based on another order defined by the user, the department, or the provider of the system. The workflow audit may also be accessible from the status tab of a report. Workflows may be marked with a high priority mark 807 (described further with respect to FIG. 12).

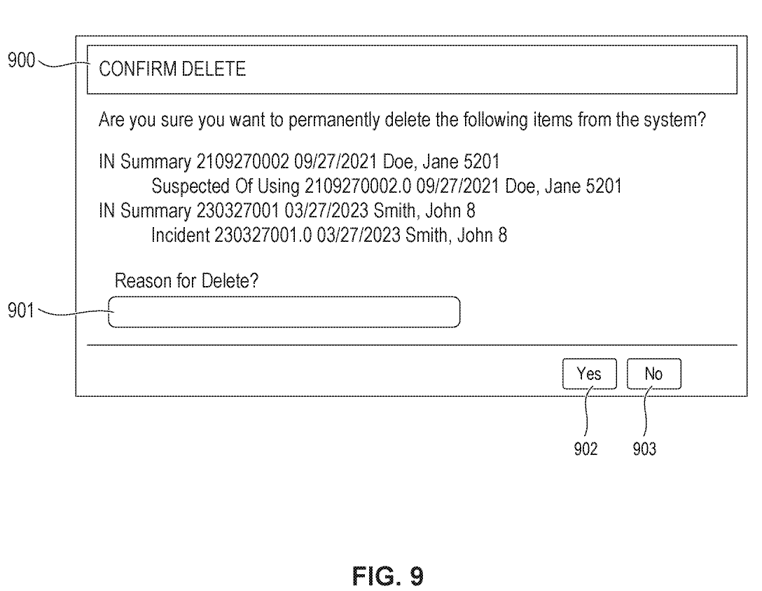

When the delete button 705 (shown in FIG. 7B) is selected, the system may display a confirm delete user interface. FIG. 9 shows an exemplary confirm delete user interface 900 that includes a summary of selected reports for deletion, and a reason for delete field 901 where the user may add comments to the deletion. Confirm delete user interface 900 may also include a yes button 902 to confirm the deletion, and a no button 903 to return to the previous screen. When yes button 902 is selected, the system may delete only the record itself or may delete the record and any associated records.

FIGS. 10A-10D are exemplary filtering menus that the user interface may display when the user selects a filtering button. The user interface may display different filtering menus based on the possible values contained in that column. The user interface may also allow the user to select different filtering methods. FIG. 10A shows an exemplary filtering menu 1000 that includes a first filter operator 1001, a first filter criterion field 1002, a connector 1003, a second filter operator 1004, a second filter criterion 1005, a filter button 1006, and a clear button 1007. The filter operators may include “is equal to,” “is not equal to,” “starts with,” “contains,” “does not contain,” “ends with,” or other filter operators. The filter menu may allow the user to submit any valid characters as the filter criterion. Allowing the user to manually enter filter criteria may not be necessary or efficient when the data contained in a column is limited to specific formats or types of data.

For example, FIG. 10B shows an alternative exemplary illustration of a filter menu. The interface may include filter menus tailored to particular data or entries, such as a date filter 1010 which would allow a user to select a date or date range on a calendar as the criterion, instead of requiring manual entry of the criterion.

Similarly, FIG. 10C is an exemplary illustration of a filter menu 1020 in which the column contains a limited set of values. Filter menu 1020 may list all possible data values 1021 for that column and allow a user to select the value or values that the user wishes to sort the column by. Once a user has entered the search criterion in any of the filter menus and then selected the filter button, the filter icon will be marked, as shown in exemplary FIG. 10D.

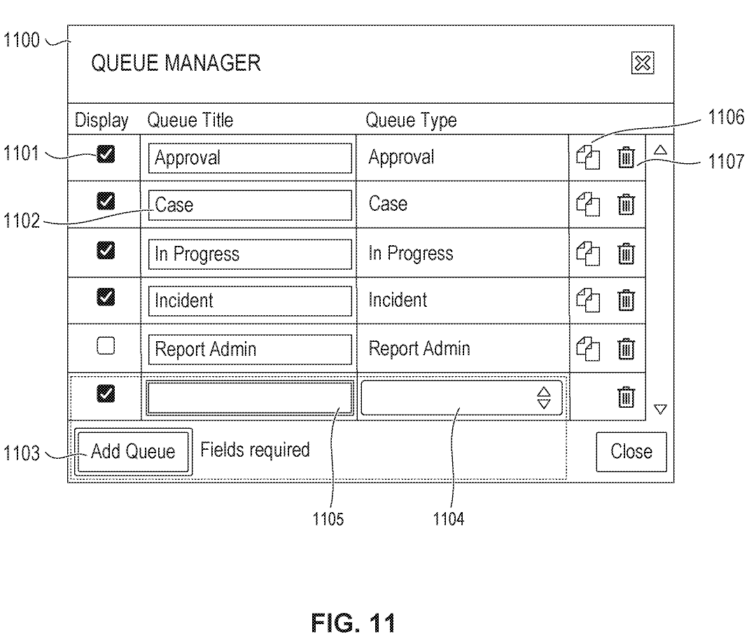

When the user selects queue button 107 (shown in FIG. 2A), the user interface may display a queue manager menu. FIG. 11 is an illustration of an exemplary queue manager menu 1100. Queue manager menu 1100 may contain display buttons 1101 that when selected by the user show the associated queue on the landing or home page and hide the associated queue when unselected by the user. Queue manager menu 1100 may allow a user to edit the title of a queue 1102 or select an add queue button 1103 to add a new queue in a new queue field 1104 with a new queue title 1105. Queue manager menu 1100 may also contain a queue copy button 1106 to allow a user to copy or duplicate a queue configuration, and a queue delete button 1107 to allow a user to delete a queue from the home or landing page.

FIG. 12 is an exemplary illustration of a data entry screen 1200. Data entry screen 1200 may be displayed by the system when a user opens a report or creates a new report. The data entry screen may contain a report header 1201, a report overview 1202, a report details 1203, and a report footer 1204. The report header 1201 may contain the name of a report 1205, a report number 1206, a case number 1207, and a report status 1208. Report header 1201 may also contain an edit icon 1209 to allow a user to edit the report. The report header may also display a juvenile warning message if any person entered in the report is a juvenile, or a report in use warning message if another user is viewing or editing the report. The report in use warning may update once the other user finishes viewing or editing the report. The report header may also include a plurality of tabs that may include a report tab, an attachments tab 1222, a case tab 1223, a documents tab 1224, a restrictions tab 1225, a status tab 1226, or other tabs. The report tab may display the report information as shown in FIG. 12.

The system may include a number control section form, accessible from a report header, that may include numbers related to the report. The number control screen may allow a user to generate a case number, manually enter a case number, modify a case number, or leave a case number blank. The number control screen may allow a user to generate a report number, manually enter a report number, modify a report number, or leave a report number blank. The number control screen may allow a user to associate a report with an offense suffix.

The attachments tab 1222 may display the attachments for a selected report. A user may be able to add attachments to a report in the report tab by uploading files or entering hyperlinks to the report tab. A user may not be able to upload attachments if they do not have permission to upload attachments. Different permissions may be required to add attachments to summary reports or completed reports. The system may allow a user to add information to an attachment in fields including a description, type, related to, offenses, or other fields. The attachments tab may allow a user to download or delete the attachments or modify the attachment information.

A tasks tab may display created tasks and allow a user to create, edit, and delete tasks. The tasks tab may appear in the report header 1201 in a manner that may be similar to other tabs such as the attachments tab 1222, the case tab 1223, and the other tabs shown in FIG. 12. Tasks may also be shown in a tasks tab of the In Progress queue. Tasks may include automatically generated tasks such as call for service tasks, arrest tasks, civil activity tasks, warrant activity tasks, and evidence dispose order tasks. If a user selects a task, the system may provide the option to clear or delete the task, or to create a new report based on the task.

The case tab 1223 may display case management information. The documents tab 1224 may list officers and generated documents associated with the selected record. Documents may include officer PDFs, generated reports, redacted reports. Officer PDFs may be generated when a workflow step is completed, or when a workflow is completed. The generated reports may display the report in document form. The documents tab may allow a user to redact a report from the generated reports or redacted reports list. A user may not be able to redact a report unless they have the necessary permission.

The restrictions tab 1225 may display the list of restrictions currently applied to the report, a section of the report, an attachment to the report, or any other document or data associated with the report. Status tab 1226 may display the workflow audit for the selected report, and a prioritize button to allow a user to mark the report as high priority. A report marked as high priority may be displayed with a high priority mark 807 as shown in exemplary FIG. 8, or have a priority label added to its report header.

Report overview 1202 may include read only information from the report, including a count of how many sections are contained in the report. Report details 1203 may include an add section button 1210 to add a section to a report. Report details 1203 may include an edit button 1211 to edit an existing section of a report, a copy button 1212 to copy a section of the report, or a delete button 1213 to delete a selection of the report. Report details 1203 may also include an expand button 1214 to expand a section of the report, or to collapse an expanded section of the report. The report footer 1204 may include a delete button 1215 to delete the entire report, a copy button 1216 to copy the entire report, a supplemental report button 1217 to create a supplemental report, an email notification button 1218 to create an email notification, a validation button 1219 to access a validations menu, a comment button 1220 to add a comment to a report, and a submit button 1221 to submit a report. Comment button 1220 may also allow a user to reply to an existing comment, edit an existing comment, or delete an existing comment. Report footer 1204 may include an amend button, reject button, or approve button.

If a user opens a report and the system displays data entry screen 1200, the system may set the report as read only. The system may set the report as read only if the report is opened while the report has completed its workflow, or when the report is opened from a workflow step that does not allow modification (e.g., at an approval step), or when the report is opened by a user who does not have permission to edit the report. Thus, the system may open a report in an editable state when the user is expected to edit, or has permission to edit, the report. Alternatively, the system may open the report in a read-only state when the user is not expected to edit, or does not have permission to edit, the report. The system may prevent a user from opening a report unless the user has permission. The user permissions may be set by the user, the department, or the system provider. A user may have permission to view all reports that the user created, or to view all reports. The user may also have permission to view all reports at a certain workflow step.

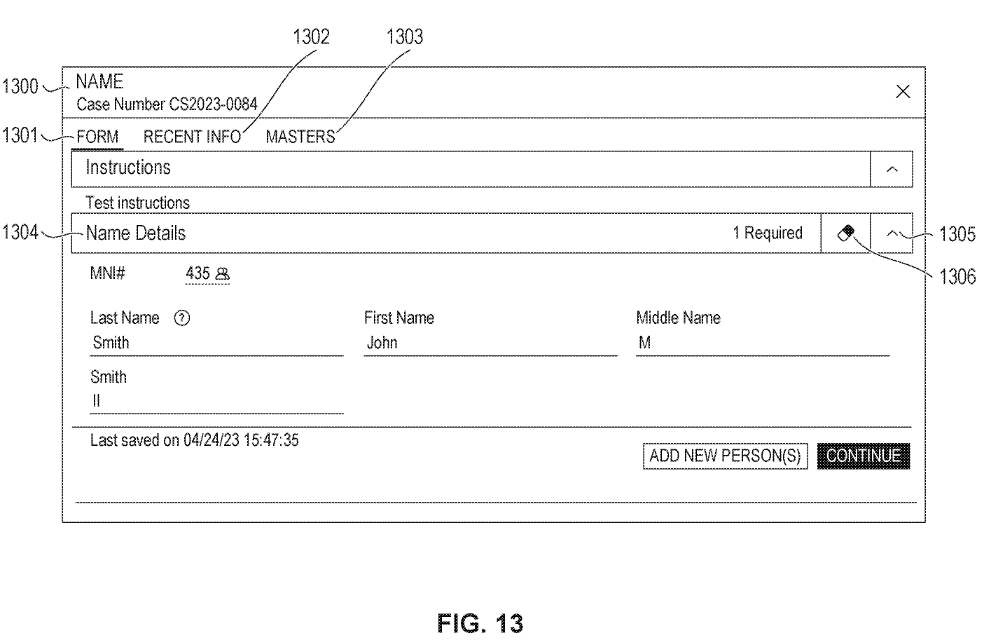

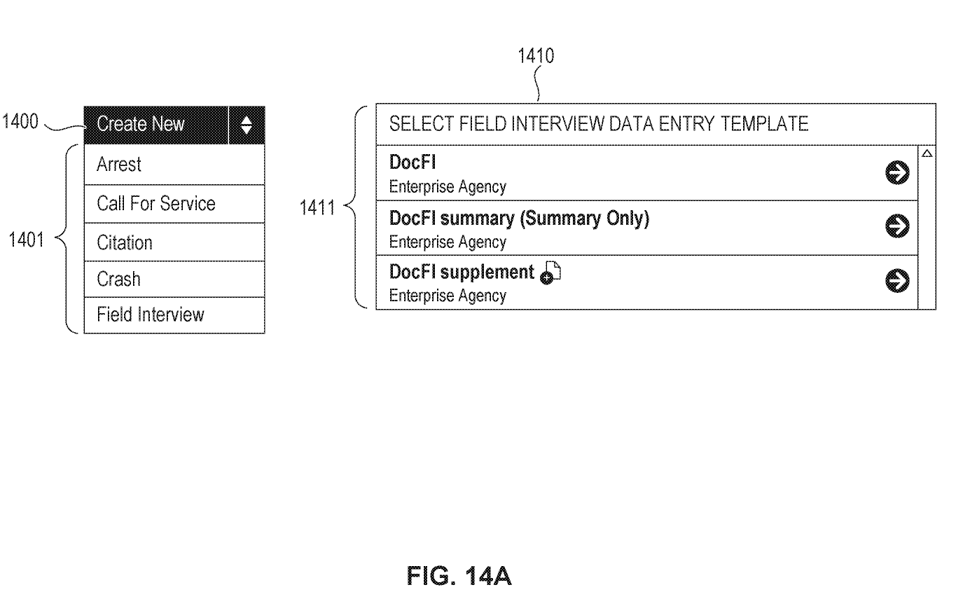

FIG. 13 shows an exemplary section form screen 1300 that may be displayed when the user selects add section button 1210 or edit button 1211 (shown in FIG. 12). Section form screen 1300 may include a form tab 1301, allowing a user to enter information such as a person’s name or other details. Section form screen 1300 may also include a recent information tab 1302 that lists recently used or inputted data for easier access by the user. Section form screen 1300 may also include masters tab 1303 that shows master record search results for the current section. Section form screen 1300 may also include a national crime information center tab or imaging tab. Within the section form screen 1300 may be a subsection 1304 with a collapse button 1305, an erase button 1306, or an add button to add a new subsection.

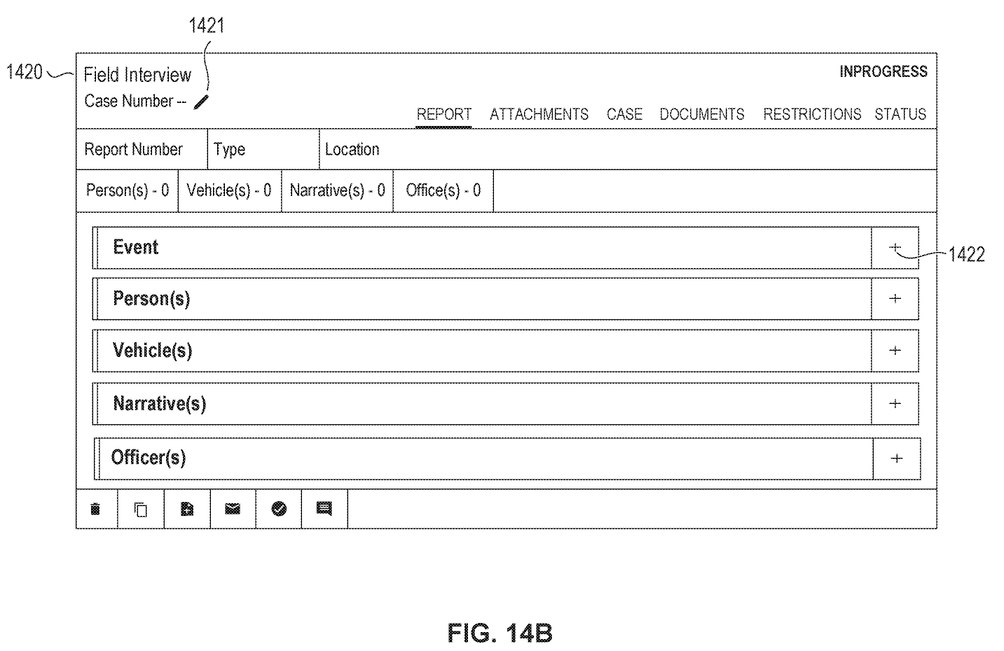

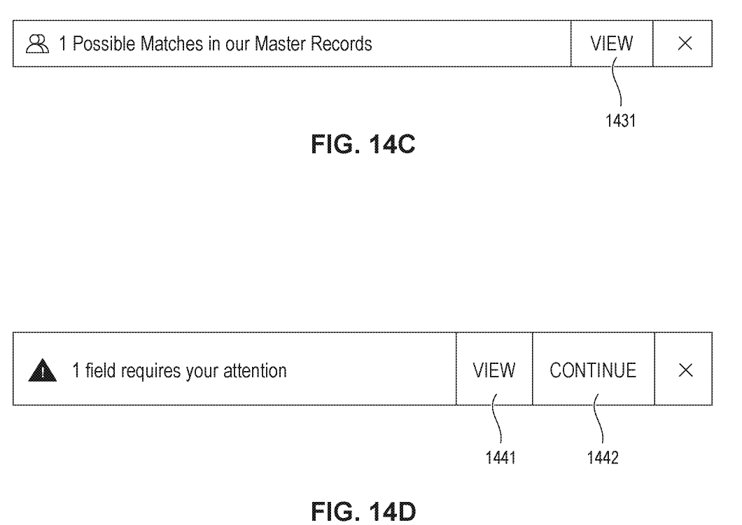

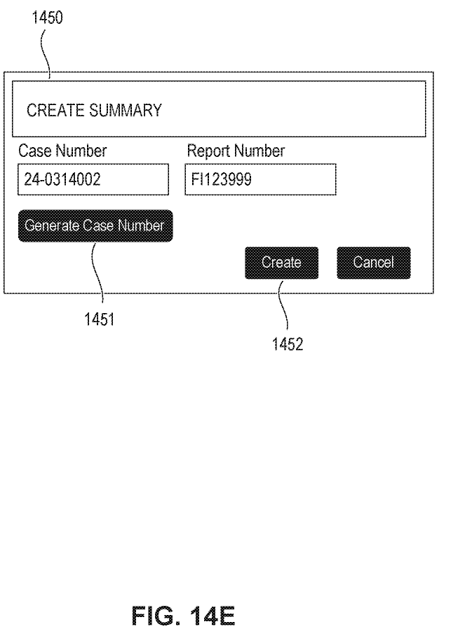

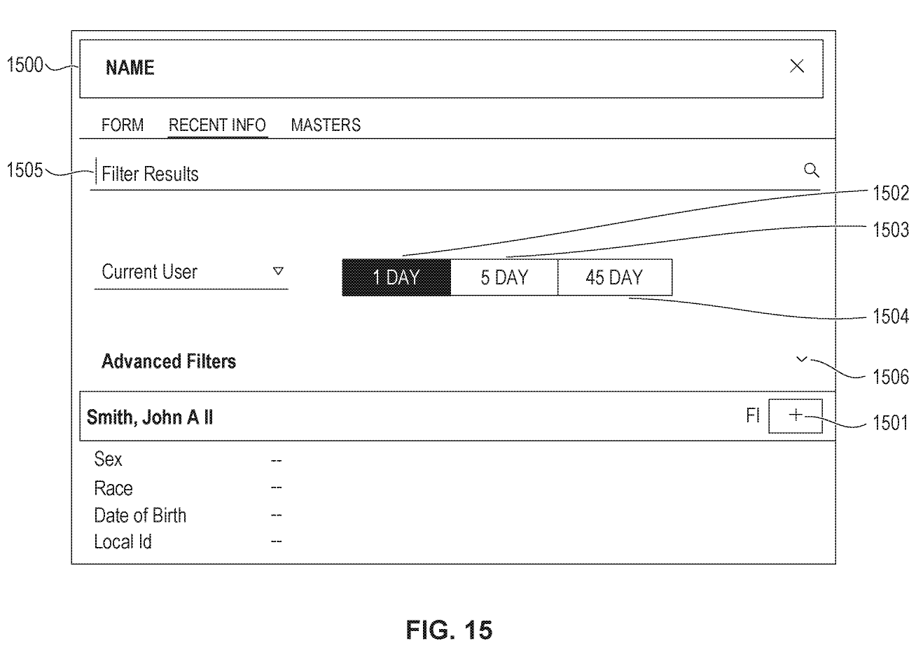

If the user selects a create new button 108 (as shown in FIG. 2A) the system may display a create new record menu 1400 as shown in FIG. 14A. Create new record menu 1400 may list record types 1401 for the user to select and create. If a user selects a record type 1401, the new record menu 1400 may then display a list of templates 1410 based on the selected record type and allow the user to select a template 1411 to create the new record from. The template list may label or identify summary records, supplemental records, or other categories of records with icons or words. Once a user selects a template, new record menu 1400 may open a blank data entry page 1420 as shown in FIG. 14B, similar to the data entry page shown in FIG. 12. Data entry page 1420 may contain an edit button 1421 to allow the user to edit the record, and new section buttons 1422 to add sections to the record. Sections may include Events, Person(s), Narrative(s), and other details that may be added to the record, as shown in FIG. 12.

If the system detects a match between a section that a user enters into the data entry page 1420, and a master record stored in the system, the user interface may display a master record match message as shown in FIG. 14C. The master record match message may contain a view button 1431 to display to a user the possible matches. The user may then select master records to link to the section. The system may also display validation errors as shown in FIG. 14D if the section contains required fields that do not yet have data. A view button 1441 may allow a user to view a list of required fields, and a continue button 1442 may allow a user to close the section without entering data in the fields that lack data.

If a user selects a summary record in list of templates 1410, the system may allow a user to create a summary record without creating a report using a create summary form 1450 as shown in FIG. 14E. The system may allow a user to generate a case number by selecting a generate case number button 1451. The system may allow a user to enter a report number, or the system may automatically generate a report number if the user selects the create button 1452 without entering a report number. If a user selects a supplemental report in the list of templates 1410, the system may allow a user to create a supplemental report. Supplemental reports may allow a user to update event data and add additional sections to existing reports. Supplemental reports may allow a user to amend summary records. A supplemental report may automatically populate the case number and report number data from the original record and may link sections in the original record to the supplemental record.

The system may save reports automatically, continuously, or at regular intervals. The system may allow a user to manually save a report. When the report is saved, the system may populate all fields of the report with default values. When a user submits or approves a report, the report may move to the next step in a workflow and move to a different queue. The system may require that validation requirements be met before a user may approve a report. When a user rejects a report, the report may be returned to the previous step in the workflow, and may be placed in a different queue, for example, the In Progress queue of the user with permissions to complete the previous workflow step. When a user rejects a report, the system may return the report to the beginning of the workflow, or to any other workflow step. The system may allow the user to add a comment to a report before rejecting a report. When a report is rejected, the system may remove information from the report, such as officer sections of the report. Approving or rejecting a report may add the officer to the workflow audit of the report. The system may allow a user to recall a report after it has been approved, rejected, created, or submitted. The system may only allow a user to recall a report prior to the workflow being completed. The user may be allowed to edit a recalled report and then approve, reject, or submit it to the same workflow step. Alternatively, the system may return a recalled report to the beginning of the workflow.

The system may save reports when they move to a new queue. When the system saves a report, or when a report moves to a new queue, the system may check whether the report has the same report number or case number as another report in the system. The system may prompt the user to confirm the report number or case number if a matching existing report is identified in the system. The system may add the second report with the matching report or case number as a supplemental report to the matching report already in the system.

If the user selects recent information tab 1302 (shown in FIG. 13), the user interface may display a recent information screen 1500 as shown in exemplary FIG. 15. Recent information screen 1500 may show data, such as event, person, property, or vehicle data, that was recently entered into the system by the user or by other users. The items may be sorted chronologically. The recent information screen may allow a user to copy the data from a previously created report into a new report by selecting a copy data button 1501. For instance, an arrest report may allow a user to copy the data from an incident report into an arrest report. The Recent Information screen 1500 may also show Department of Motor Vehicles (DMV), Department of Transportation (DOT), or Registry of Motor Vehicles (RMV) data. If a user selects one of the time filter buttons 1502-1504, the recent information may be filtered to the respective time range shown on the selected time filter button. If the user enters text into a filter results field 1505, the system may filter results to those that match or contain the text. If a user selects an advanced filters button 1506, the user may be able to select specific record types and data types to filter the recent information by. The user may also be able to select what agencies’ or departments’ information is included in recent information screen 1500. The system may limit what types of data may be copied from the recent information screen.

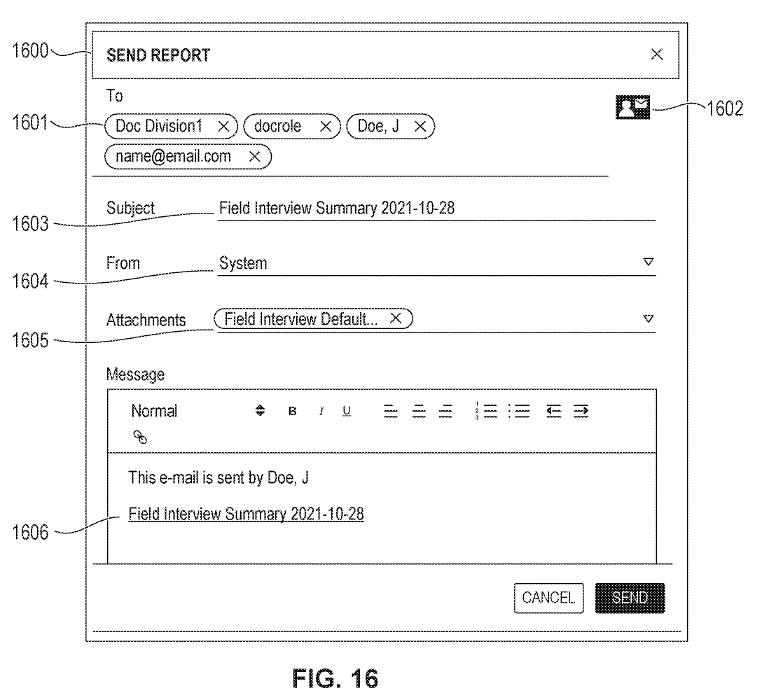

If a user selects the email notification button 1218 (shown in FIG. 12), the user interface may display a send report form 1600, as shown in FIG. 16. A user may enter recipients directly into a “To” field 1601 or select a recipients button 1602 to search for recipients. Recipients may be searched for based on their role, agency, department, division, username, first name, last name, badge number, or email address. The system may set a subject 1603 of the email automatically. Subject 1603 may be set to the report type and number. The user may be able to manually modify subject 1603. The system may set a “From” field 1604 of the email automatically. “From” field 1604 may be set to the system. The user may be able to manually modify “From” field 1604. For example, the user may be able to enter or set their own email address in “From” field 1604. By selecting an attachments field 1605, the user may be able to add attachments to the email. The system may set a body 1606 of the email automatically. The user may be able to edit body 1606 of the email.

If a user selects validations button 1219, (shown in FIG. 12) the user interface may display validations screen 1700, shown in FIG. 17A. The system may display validation error notifications directly in an exemplary data entry page as shown in FIGS. 17B and 17C. A validation button 1701 may display a notification icon 1702 when there are unresolved validation errors in the report. Validation screen 1700 may include a validation pane 1703 that lists all the validation errors in the report. Validation screen 1700 may identify field level validation errors, i.e., data that does not comply with the requirements of the field. For example, a field may require a number with a certain format (e.g., height, time, dates), or an empty field may be required. A validation error 1711 is an example of a validation error that may occur when a particular victim type is selected, and the field validation requires that the corresponding related offenses field be set to one of the listed offenses. Validation screen 1700 may identify a section level validation error 1704 where a required section is missing. The system may mark sections that have no validation errors with a valid icon 1721 and sections that have validation errors with an error icon 1722. Validation rules may be set by the user, the department, or by the system provider. Validation rules may be based on state reporting requirements. The system may prevent a report from being submitted or approved while there are unresolved validation errors.

When the user enters data into the user interface, the user interface may dynamically update based on the entered data. For example, if a user enters a start date in a start date field, the system may dynamically update the dates available when a user attempts to select an end date in an end date field. In another example, if a user enters murder as an offense in an offense field, the system may dynamically update the report to include a weapons field or may dynamically update the list of weapons available to select for a weapons field. The system may automatically populate fields. For example, if there is only one remaining valid entry for a field based on a dynamic update, the system may populate the field with that valid entry. The system may automatically populate some fields by calculation or other process. For example, the system may populate an age field with data using a provided date of birth, or may populate a total fees field based on the fees already listed in a report. The system may activate, deactivate, require, or otherwise modify fields based on a dynamic update.

The system may display messages on already populated fields instead of setting the field data if the dynamic update would otherwise set the field data. The system may also prevent editing of some fields, such as read only fields. The user, the department, or the system provider may designate fields as read only. Read only fields may not be changed by dynamic updates. The user interface may automatically populate some fields with default data. For example, a current date field may automatically populate with the current date. A user may edit a field that was automatically populated with a default data. Default data may be set by the user, the department, or the system provider. The user interface may include fields such as but not limited to free text fields, date and time fields, date of birth and age fields, single drop-down lists, multiple drop-down lists, check box fields, required fields, read only fields, related to fields, vehicle fields, vehicle owner fields, scars marks and tattoos fields, offenses and charges fields, violation codes fields, calculated fields, address fields, alias fields, narrative fields, and electronic signature fields.

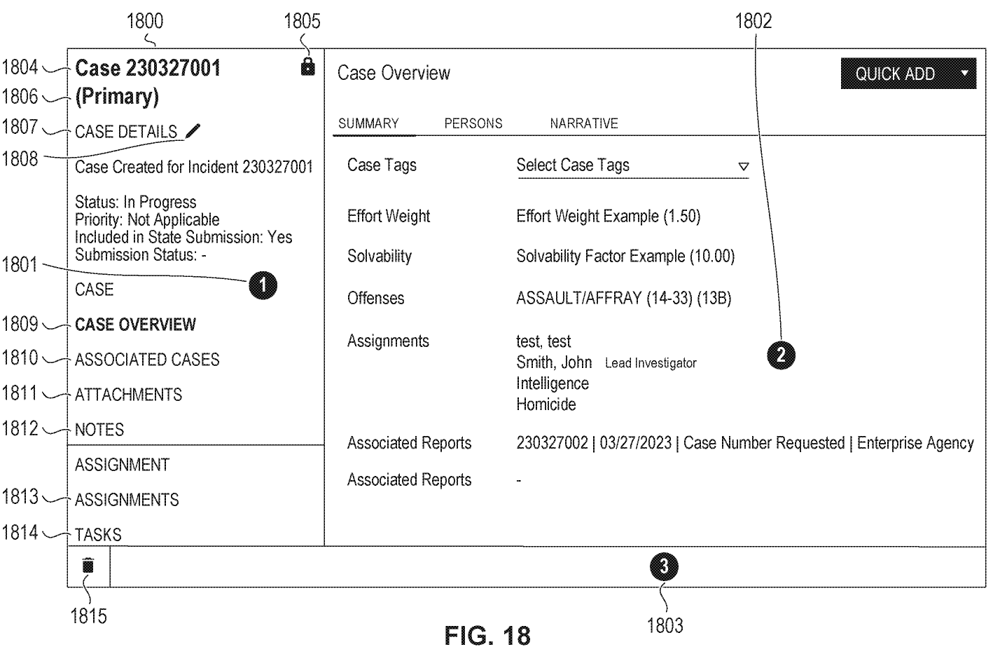

FIG. 18 is an exemplary case management user interface 1800. Case management user interface 1800 may be displayed if a user selects a case in a case queue or selects a case number in a record. The system may automatically generate a case record when a user generates or enters a new case number. The system may generate a case record at any step in a workflow. Alternatively, the system may only generate a case record when the record completes its workflow.

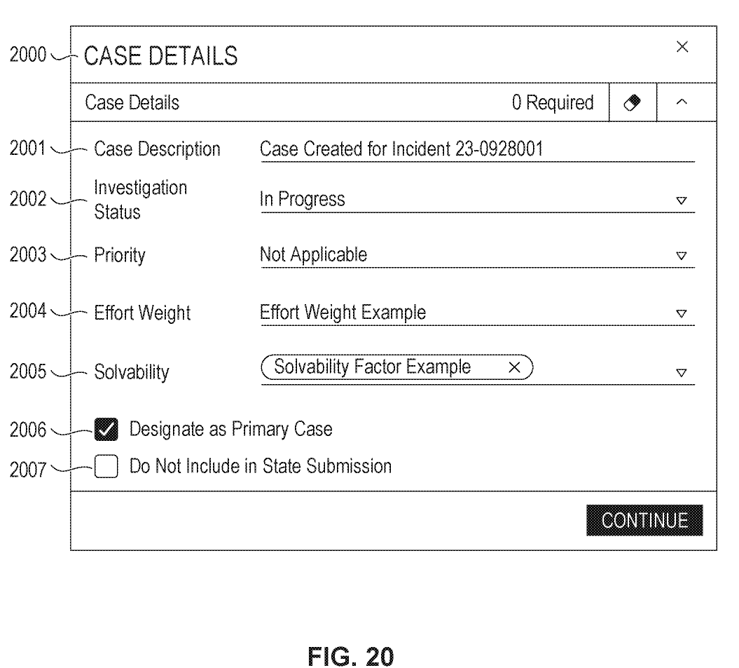

Case management user interface 1800 may include a left pane 1801, a content pane 1802, and a footer 1803. Left pane 1801 may include a case number 1804 and a restrictions icon 1805. Left pane 1801 may include a primary designator 1806 if the case is a primary case (as described further with respect to FIG. 20). Left pane 1801 may include case details 1807 including a status, priority, included in state submission, and submission status data. Left pane 1801 may include an edit button 1808 to edit the case details 1807. Left pane 1801 may include navigation buttons including a case overview button 1809, an associated cases button 1810, an attachments button 1811, a notes button 1812, an assignments button 1813, a tasks button 1814, or other buttons including an offenses button, a case packet button, a state reporting button, a restrictions button, an evidence button, or an audit button.

If the user selects the case packet button, the system may export all the officer reports and attachments in a case into a compressed file, such as a ZIP file. The system may allow a user to filter the case packet to only include records associated with a particular offense or a particular person. The system may allow a user to manually select which items in the case packet to export. The system may provide an estimated file size of the exported file. The system may allow a user to add a note to the case packet before exporting the case packet. The system may allow the user to choose whether to export the selected files as one file or as individual files. The system may allow a user to export the files to a digital evidence management system.

Content pane 1802 may include information based on the navigation button that the user selects in Left pane 1801. Footer 1803 may include a delete button 1815. If the user selects delete button 1815, the system may delete the entire case. The system may require the user to fill in a reason for delete field prior to deleting the case.

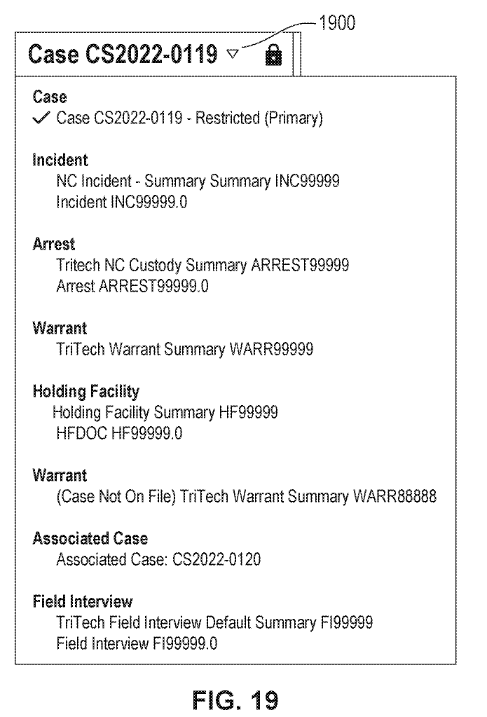

If the user selects a case number 1804, the system may display a case navigation menu. FIG. 19 illustrates an exemplary case navigation menu user interface 1900. Case navigation menu 1900 may list a case and all records or cases associated with the selected case. Listed cases and records may be designated with labels including a primary label, draft label, reporting officer label, reporting date label, restriction label, restriction expiration date label, case not on file label, or other labels. The system may limit which cases and records appear in the case navigation menu, based on a user’s permissions or rights.

If a user selects edit button 1808, the system may display a case details user interface for editing case details. FIG. 20 shows an exemplary case details user interface 2000. Case details user interface 2000 allows the user to edit case details 1807 in left pane 1801 (as shown in FIG. 18). Case details user interface 2000 may allow a user to edit fields such as a case description 2001, an investigation status 2002, a priority 2003, an effort weight 2004, and a solvability 2005. The investigation status 2002 may be set to closed or inactive, closing all associated case tasks. The priority 2003 may be set to one of several priority levels used to identify cases of higher or lower priority. The effort weight 2004 and solvability 2005 may be automatically calculated values that represent how hard the case will be to solve. Case details user interface 2000 may also allow a user to set the case as a primary case using a designate as primary case checkbox 2006, or to not include the case in state submissions using a do not include in state submission checkbox 2007. A primary case may display the information for all associated records in addition to the primary case itself when viewing the case record.

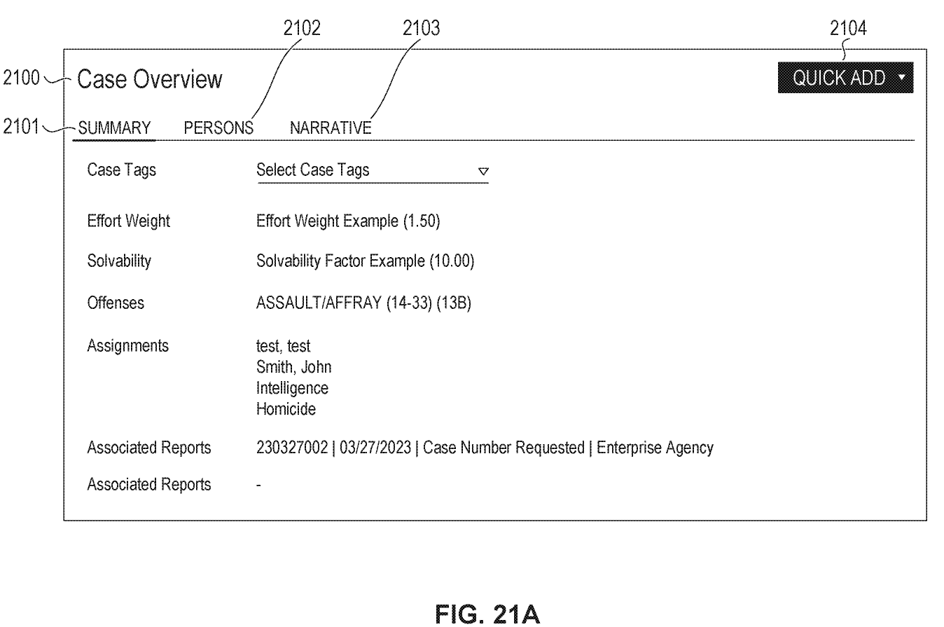

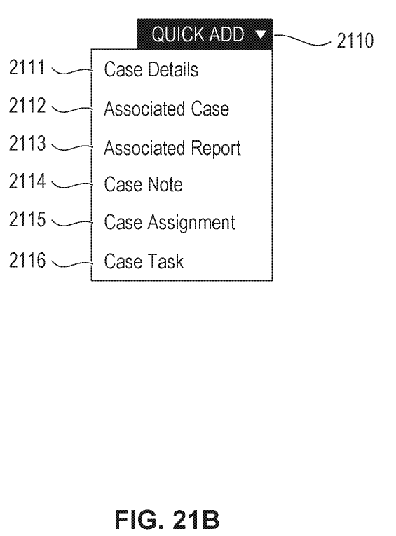

If a user selects case overview button 1809 (shown in FIG. 18.), the system may display a case overview user interface. FIG. 21A shows an exemplary case overview user interface 2100. Case overview user interface 2100 may include a summary tab 2101 which displays a list of all associated cases and associated reports. The case overview user interface 2100 may include a persons tab 2102 and a narrative tab 2103 that list all people and narratives (respectfully) or all associated cases and associated reports. Narratives may include additional information, including significant events, that a user adds to a record as text. Persons tab 2102 and narrative tab 2103 may include a total count and a display by field to change the sort order. Case overview user interface 2100 may include a quick add button 2104 and a watch toggle. If a user selects the watch toggle, the system may email the user when changes are made to the record by other users. Selecting the watch toggle again, the system may stop emailing the user when changes are made. The system may automatically send a user emails when they are assigned a case or when a case assigned to that user is changed.

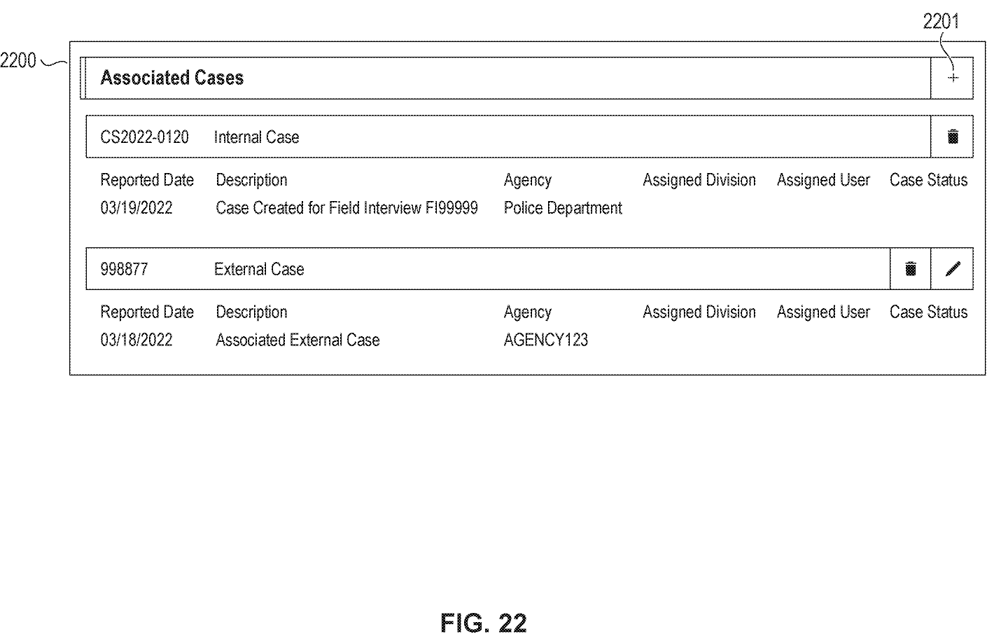

If a user selects quick add button 2104, the system may display a drop-down menu 2110 as shown in FIG. 21B. Drop-down menu 2110 may include buttons such as a case details 2111, an associated case 2112, an associated report 2113, a case note 2114, a case assignment 2115, a case task 2116, and other buttons that each open a user interface matching the selected button in order to add information corresponding to the selected button to the case. For example, if a user selects the button associated case 2112, the system may display an associated case user interface as shown in FIG. 22. Thus, the user can add or edit information in the case overview (as shown in FIG. 21A) by selecting the button in the drop-down menu 2110 corresponding to the type of information the user intends to add.

If a user selects associated case button 1810 or 2112, the system may display an associated cases user interface. FIG. 22 shows an exemplary associated cases user interface 2200. Associated cases user interface 2200 may list any cases or record that have been associated with the currently selected case. Associated cases user interface 2200 may include an add button 2201 to associate a new case with the currently selected case.

If a user selects attachments button 1811 (shown in FIG. 18), the system may display an attachments interface to allow the user to view all the files attached to the case. The attachments interface may include buttons to add, remove, sort, edit, or download the attachments. If a user selects notes button 1812 (shown in FIG. 18), the system may display a case notes interface. The case notes interface may include buttons to add, remove, or edit case notes. If a user selects the assignments button 1813 (shown in FIG. 18), the system may display an assignment user interface. The assignment user interface may include fields and buttons to allow a user to assign a case to a division or user, or delete a current assignment. The system may display the number of cases assigned to each user or division in a user interface. The system may differentiate between cases where a user is a lead investigator or not. The system may allow the user to select one or more users or divisions to assign the case to, or to make a lead investigator. The system may set the first person assigned the case as a lead investigator. The assignment user interface may include a history of assignments for the currently selected case.

The system may provide a case load user interface to allow a user to assign multiple records to a division or user at the same time. The user may select multiple records in the case load user interface, and assign all of them to the selected user with a single action. A user may also edit details of the plurality of selected records at the same time. The case load user interface may also display the total number of cases assigned to each user, or assigned to a division, as well as the total effort weight and average solvability of the cases assigned to each user.

The system may automatically send email notifications to users when certain actions are taken, including when a case is assigned to a division or a user, closed or has its status or priority changed, or when a task is assigned, modified, or overdue. The system may allow a user or department to configure additional email notifications to occur when other actions occur. Recipients of an email notification may include the users in a division, the lead of a division, the user performing the action, or other predefined users.

The system may allow a user to view or edit a master record directly. Master records may be edited from the data entry user interface or from a search user interface. A master record may contain a record image, a navigation menu, a header, alerts, overview information, and a content area. Alerts may be attached to a record and then viewed from the individual items within the master record. The system may automatically generate alerts if predefined conditions are met, such as if a person is currently confined to jail, or has an active or unserved warrant or civil paper. The navigation menu may include an involvements button to open an involvements page which may show summary reports that are linked to the master record. The navigation menu may include a timeline button to open a timeline page which shows the summary reports linked to a master record in chronological order. The navigation menu may include a gang qualification button to open a gang qualification page that lists gang qualification information in the records associated with the master record. The navigation menu may include a link analysis button to open a link analysis page which displays a visual representation of all the reports associated with the master record.

A master record may allow a user to view the reports associated with the master record. A master record may allow a user to view all the attachments, notes, custom fields, personal details, or other information contained in any of the reports associated with the master record.

The system may associate any records that do not have sufficient information to associate with a master record, to a predefined master record. The system may associate those records to another master record when sufficient information is added to allow them to be associated to a master record. The system may include other predefined master records that are associated with individual records that meet specific criteria, for example expunged records, that may not be associated with other master records.

The system may enable state reporting and validation through a variety of features and user interfaces. The system may allow a user to enter information that is not compatible or accepted by a state submission. The system may automatically select for the user what information may be or is required to be submitted in a state reporting submission. The system may combine duplicate records and for submission as one record. The system may also validate the data in a record or case to ensure that the data meets the requirements of state reporting. The system may provide a correct errors button in a state validation user interface to allow a user to correct errors in a record or case. The system may allow a user to generate a report for state reporting, in a form that is required by state reporting requirements, based on a selected cases or reports or records. The system may allow a user to generate reports manually. The system may be able to generate statistical reports, as a database table, data model, or in other forms.

The system may allow a user to expunge records and data from the entire system when necessary. Expunged records and data may be based on a name, organizations, related charges, properties, drugs, attachments, narratives, memos, or other fields for expungement. The system may allow a user to seal records or may allow a user to print a record to a hard copy and then expunge the record. The system may allow a use to print a summary of expungements that have been performed.

The system may restrict access to cases, reports, or sections of a report to users with a required permission level. The system may allow the user to create restrictions and apply or remove those restrictions to a case, report, or section of a report. The restrictions may include an expiration date, after which the restrictions may no longer prevent a user without permission from viewing the restricted information. The system may display an icon to identify a case, report, or section of a report that is restricted. The system may not display restricted content (such as in search results) to a user that does not have permission to view that content. The system may display a collapsed section or other representation of restricted content to a user that does not have permission to access the content, without allowing the user to access the restricted content.

The system may include the ability to track items, such as property and evidence, and provide user interfaces for doing so. Property and evidence may be tracked by individual item. Property and evidence may be tracked within a group and not individually. The system may automatically assign every item a unique identifying number or barcode. The system may allow a user to enter the unique identifying number or barcode. The system may automatically assign every item a number that is representative of the case or report that the item is associated with, but unique from other items associated with that case. The system may require a user approve a new item that is added to the system.

The system may provide evidence queues and lists to display items already entered into the system. Lists may be created by the user based on criteria the user selects to filter the items in the system. The system may allow a user to add or remove individual items from a list. The system may allow a user to add an item to a tracker to allow the user to manage or work with that item. The system may allow a user to add details and other data to the item including a do not remove reason, notes, attachments, chain of custody, inventory log, associated cases, related contacts, and evidence lists. The system may allow a user to perform actions including viewing and modifying item details, viewing a read-only evidence item record, deleting items, generating form letters, printing evidence item labels, splitting evidence items, flagging evidence items, working with dispose orders, and other actions. The system may allow a user to initiate an inventory check, and then list all or some of the items in a selected location.

The system may be configured to maintain some or all of its functionality offline. Data entry may be permitted when there is no online connection, and then the data may be saved when the system establishes a connection. Access to reports and other data offline may require a user pin. The system may display a notification that the system is offline when the system loses connection. The notification may be in the form of a banner or other user interface element. The notification may persist until a connection is reestablished and the system is online. The system may be restricted to only show certain user interface pages when the system is offline. The system may only display reports that are in progress or that the user is currently editing. The system may allow the user to create new reports when offline.

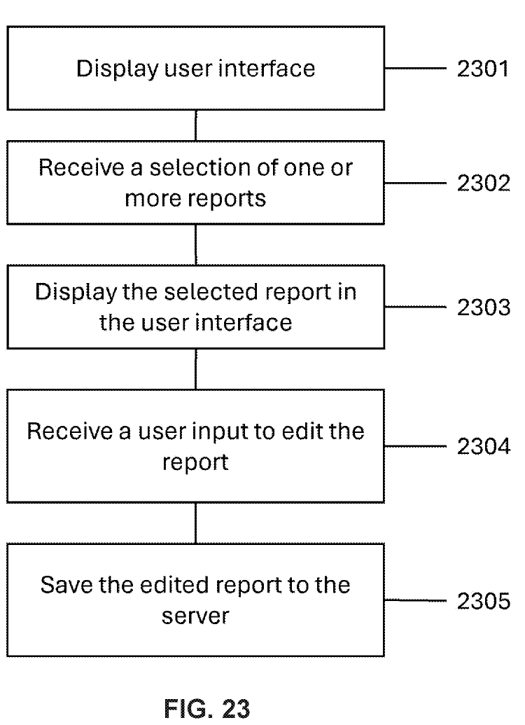

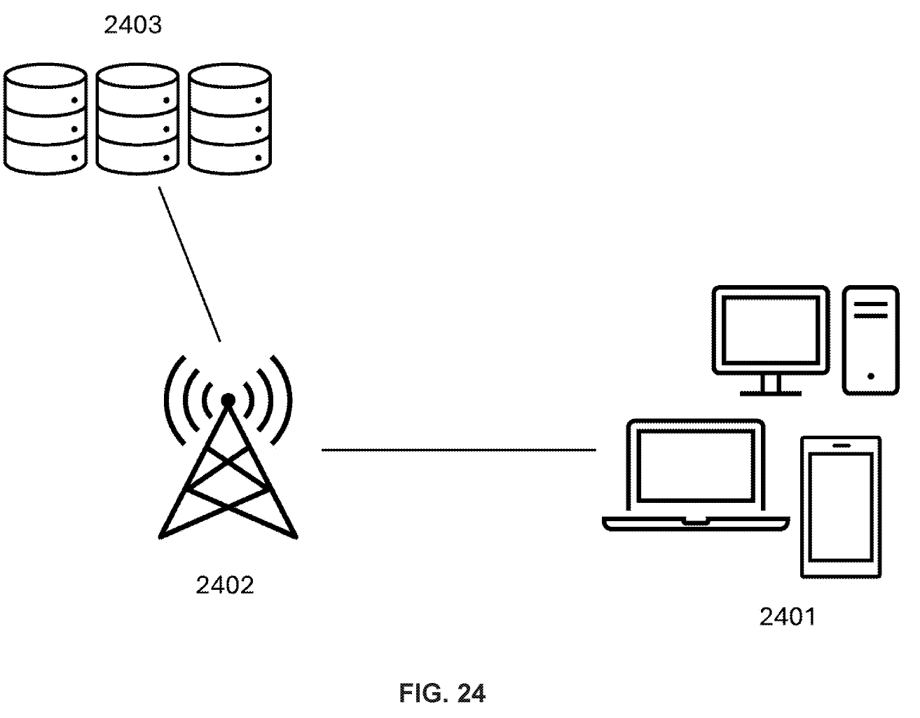

FIG. 23 illustrates an exemplary flow chart for an operation of the system, consistent with disclosed embodiments. The system may include a server; one or more memory devices storing instructions, and one or more processors configured to execute instructions. The instructions may perform steps including the steps shown in FIG. 23. At step 2301, the system may display a user interface, the user interface comprising a title bar, a plurality of queues, each of the plurality of queues containing one or more reports, and a slide out menu. At step 2302, the system may receive a selection of one of the one or more reports. At step 2303, the system may display the selected report in the user interface. At step 2304, the system may receive a user input to edit the report. At step 2305, the user may save the edited report to the server.

FIG. 24 is diagram of an exemplary system environment, consistent with disclosed embodiments. The components and arrangements shown in FIG. 24 are not intended to limit the disclosed embodiments, and the components used to implement the disclosed systems and methods may vary. The system environment may include one or more user devices 2401. User device 2401 may be one or more of a desktop computer, a laptop, a tablet, a smartphone, a multifunctional watch, a pair of multifunctional glasses, a tracking device, or any suitable device with computing capability. User device 2401 may comprise a memory, a processor, and/or other specialized hardware that is configured to execute one or more methods of the disclosed embodiments. User device 2401 be configured to enable user device 2401 to communicate with, for example, one or more servers 2403 via network 2402 and/or a local network. Additionally, user device 108 may connect to server 2403 through use of web browser software via network 2402 and/or a local network. Finally, user device 2401 may provide a graphical user interface to enable users to view data from the user device 2401 generated by an application thereon and obtained over network 2402.

Database 2403 may include one or more memory devices that store information. By way of example, databases may include Oracle TM databases, Sybase TM databases, or other relational databases or non-relational databases, such as Hadoop sequence files, HBase TM , or Cassandra™. The databases or other files may include, for example, data and information related to the source and destination of a network request, the data contained in the request, etc. Systems and methods of disclosed embodiments, however, are not limited to separate databases. Database may include computing components (e.g., database management system, database server, etc.) configured to acquire and process requests for data stored in memory devices of database and to provide data from database. The system environment may include one or more networks 2402. In some embodiments, system environment 100 may include one or more networks 2402. Network 2402 may comprise any computer networking arrangement used to exchange data. For example, network 2402 may be the Internet, a private data network, a virtual private network (VPN) using a public network, and/or other suitable connections that enable the components of the system environment to send and acquire information. Network 2402 may also include a public switched telephone network ("PSTN") and/or a wireless network such as a cellular network, wired Wide Area Network, Wi-Fi network, and/or another known wireless network (e.g., WiMAX) capable of bidirectional data transmission.

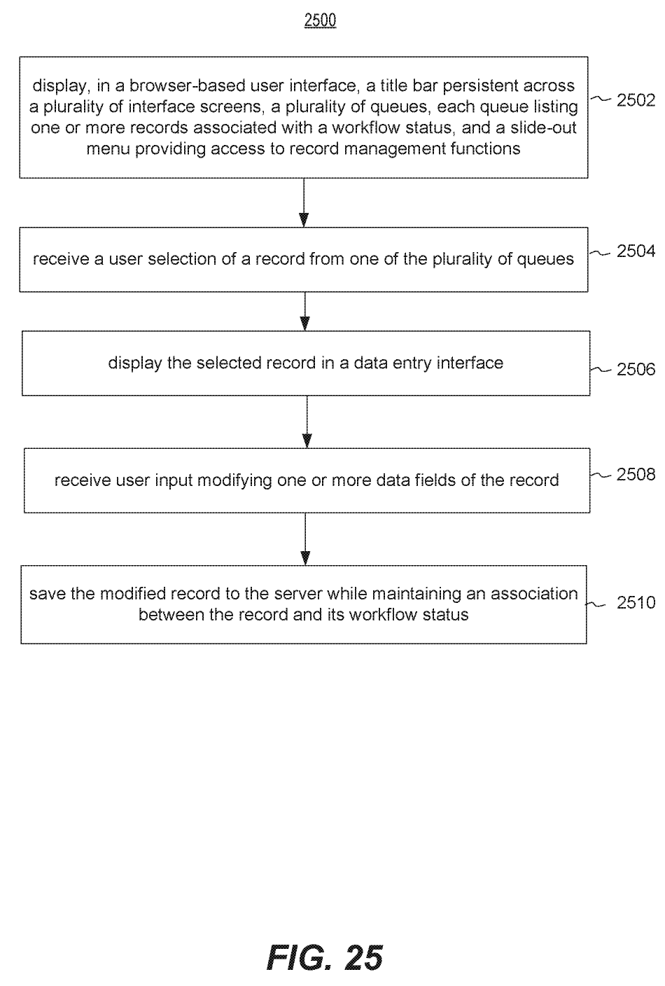

FIG. 25 illustrates an exemplary flowchart 2500 depicting operations that may be performed by a records management system consistent with disclosed embodiments. Flowchart 2500 may operate in conjunction with the user interfaces described with respect to FIGS. 1–22 and may be implemented by one or more processors executing instructions stored in memory on a server. In some embodiments, flowchart 2500 may represent a core interaction loop through which users locate, edit, and advance records through workflow states using a queue-based interface. While the steps are illustrated in a particular order, one or more steps may be performed in a different order, repeated, or omitted depending on configuration or user permissions.

At step 2502, the system may display, in a browser-based user interface, a title bar that is persistent across a plurality of interface screens, a plurality of queues, and a slide-out menu providing access to record management functions. The persistent title bar may provide consistent access to global controls, such as navigation, search, or user account actions, regardless of which queue or record view is currently displayed. Each of the plurality of queues may list one or more records associated with a corresponding workflow status, such as “In Progress,” “Approval,” or “Completed,” allowing users to visually organize work by state rather than by file location. The slide-out menu may expose additional system features, including administrative tools, configuration options, or access to other record types, enabling the user to interact with a wide range of system functionality without leaving the primary workspace. From a real-world perspective, this step may allow a user, such as an officer or records clerk, to immediately understand what work requires attention and what stage each record is in, without navigating through multiple disconnected screens.

At step 2504, the system may receive a user selection of a record from one of the plurality of queues. The selection may be received through a user interaction such as clicking, tapping, or otherwise selecting a row or card representing the record within the queue. Upon selection, the system may identify the selected record using a unique identifier and retrieve the associated record data from the server or a connected database. In some embodiments, the system may also determine the user’s permissions and the record’s current workflow status to control whether the record is opened in an editable or read-only state. This step enables queue-centric interaction, where users initiate work directly from workflow-organized queues rather than from search results or file hierarchies. As a practical example, a supervisor reviewing pending reports may select a record directly from an “Approval” queue, rather than navigating through multiple menus to locate the report.

Proceeding to step 2506, the system may display the selected record in a data entry interface. The data entry interface may present structured fields, sections, and tabs corresponding to the record type, such as event details, persons involved, narratives, or attachments. In some embodiments, the interface may dynamically load only the portions of the record needed for display, improving responsiveness and reducing network usage. The system may also visually indicate the record’s workflow status, validation state, or priority within the data entry interface. This step allows the user to view and interact with the substantive content of the record in a single, coherent interface. For example, a user editing an incident report may see all relevant sections organized logically, rather than spread across multiple applications.

At step 2508, the system may receive user input modifying one or more data fields of the record. The user input may include entering text, selecting values from drop-down menus, attaching files, or otherwise updating record information. In some embodiments, the system may perform real-time validation or dynamically adjust the data entry interface based on the entered information, such as enabling or requiring additional fields when certain values are selected. These dynamic behaviors may help prevent errors and guide the user toward completing the record correctly. From a practical standpoint, this step allows users to correct, supplement, or finalize record information as part of their workflow responsibilities. For instance, an officer may update narrative details or add involved persons while the system ensures required fields are completed.

At step 2510, the system may save the modified record to the server while maintaining an association between the record and its workflow status. Saving the record may include persisting the updated data fields to a database, updating metadata such as timestamps or user identifiers, and recording any workflow-related changes. In some embodiments, the system may also update an audit trail reflecting the modification and may trigger workflow logic that determines whether the record remains in the current queue or transitions to another queue. The workflow status association ensures that the record continues to appear in the appropriate queue following the save operation. This step allows changes to be reliably stored and reflected across the system for other users and processes. For example, once a report is saved and submitted, it may automatically move from an “In Progress” queue to an “Approval” queue without additional user action.

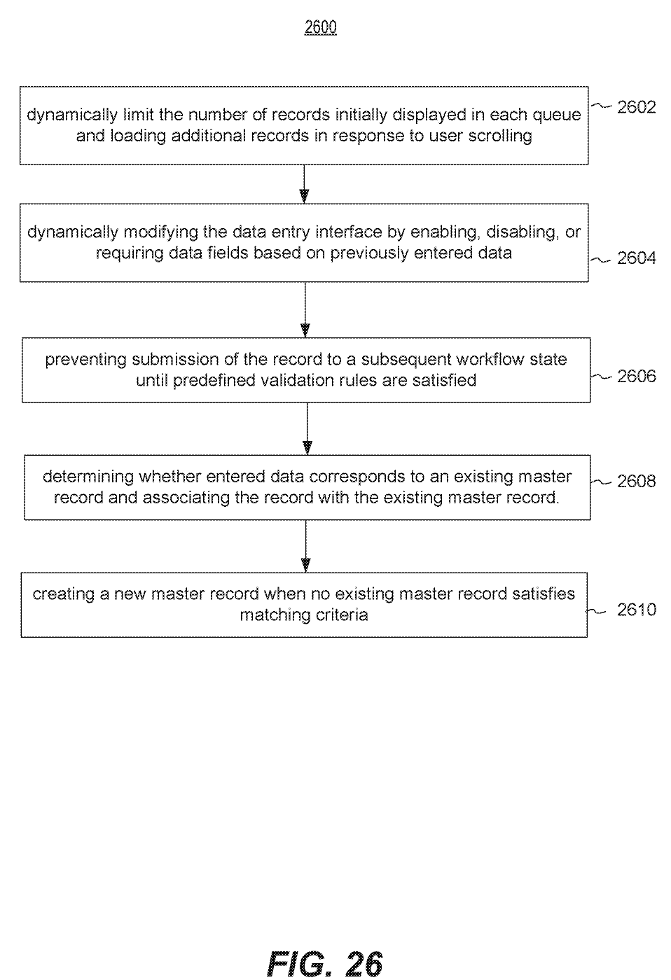

FIG. 26 illustrates an exemplary flowchart 2600 depicting additional operations that may be performed by the disclosed records management system. Flowchart 2600 may operate in conjunction with, supplement, or partially overlap with the process 2500 described with respect to FIG. 25. In some embodiments, the steps of flowchart 2600 may be invoked during record viewing or editing, while in other embodiments one or more steps may be executed automatically in the background based on system configuration or user interaction. Any of the steps described herein may be skipped, repeated, performed out of order, or executed concurrently with other steps, depending on workflow design, user permissions, or system state.

At step 2602, the system may dynamically limit the number of records initially displayed in each queue and load additional records in response to user scrolling. Rather than loading all records associated with a queue at once, the system may retrieve and render an initial subset of records to improve interface responsiveness and reduce memory or network usage. As the user scrolls through the queue, the system may detect the scrolling action and request additional records from the server, appending them seamlessly to the displayed list. This dynamic loading behavior may allow the system to scale efficiently even when queues contain large numbers of records. In a real-world scenario, a user reviewing hundreds or thousands of reports may experience faster load times and smoother interaction, since only the records currently needed for display are retrieved. This approach may also reduce delays on mobile devices or lower-bandwidth connections while maintaining a consistent user experience.

At step 2604, the system may dynamically modify the data entry interface by enabling, disabling, or requiring data fields based on previously entered data. As a user enters or selects information in one field, the system may evaluate predefined rules and adjust other fields accordingly. For example, selecting a particular record type or offense category may cause additional fields to appear, become required, or be disabled if not applicable. These modifications may occur in real time, without requiring the user to reload the interface or navigate to a different screen. This dynamic behavior may guide users toward entering complete and context-appropriate information while reducing confusion and unnecessary data entry. For instance, a user entering a field interview record may only see fields relevant to that record type, helping ensure accuracy and efficiency during data entry.

At step 2606, the system may prevent submission of a record to a subsequent workflow state until predefined validation rules are satisfied. The validation rules may include requirements such as mandatory fields, allowable value ranges, logical consistency between fields, or compliance with jurisdiction-specific reporting standards. When one or more validation rules are not met, the system may block workflow advancement while allowing the user to continue editing the record. Visual indicators may be displayed to identify which portions of the record require attention. This step may help ensure that records are complete and compliant before advancing to review or approval stages. In practice, this may reduce rework and delays by preventing incomplete or invalid records from being routed to supervisors or downstream systems.

At step 2608, the system may determine whether entered data corresponds to an existing master record and associate the record with the existing master record when a match is identified. The determination may involve comparing entered information, such as names, identifiers, or addresses, against a master record database that stores shared entities across multiple records. In some embodiments, the system may present potential matches to the user for confirmation before establishing the association. Associating records with master records may allow information to be reused and linked consistently across the system. For example, when a user enters information about a person previously involved in another report, the system may associate the new record with the existing person master record, allowing related records to be viewed together. This may improve data consistency and reduce duplication across the system.

At step 2610, the system may create a new master record when no existing master record satisfies matching criteria. Creating a new master record may include storing identifying information and establishing a unique identifier that can be referenced by future records. In some embodiments, the new master record may initially contain limited information and may be augmented as additional records are associated over time. This approach may allow the system to accommodate new entities while preserving the integrity of the master record structure. In certain implementation, this step may occur when a record references a person, location, or object that has not previously appeared in the system. By creating a new master record, the system may ensure that future records involving the same entity can be consistently linked and managed.

In some embodiments, the user interface described in FIGS. 25 and 26 may be accessible via a web browser executing on a mobile computing device or a desktop computing device. This browser-based access may allow users to interact with the system from a variety of locations without requiring installation of specialized client software.

In some embodiments, the slide-out menu may include selectable controls for accessing records, administrative functions, and configuration tools. These controls may allow users with appropriate permissions to manage system settings, customize workflows, or access additional modules without leaving the primary interface.

In some embodiments, each of the plurality of queues may include a queue-specific action menu enabling operations selected from viewing, filtering, grouping, exporting, or deleting records. These queue-level actions may allow users to perform common tasks directly within the queue context, reducing the need for navigation to separate screens.

Flowchart 2600 illustrates how the disclosed system enhances usability, scalability, and data integrity through dynamic interface behavior, validation control, and master record management. When used in conjunction with process 2500, these operations may provide a flexible and efficient framework for managing records as they move through various workflow states while maintaining consistency and accuracy across the system.

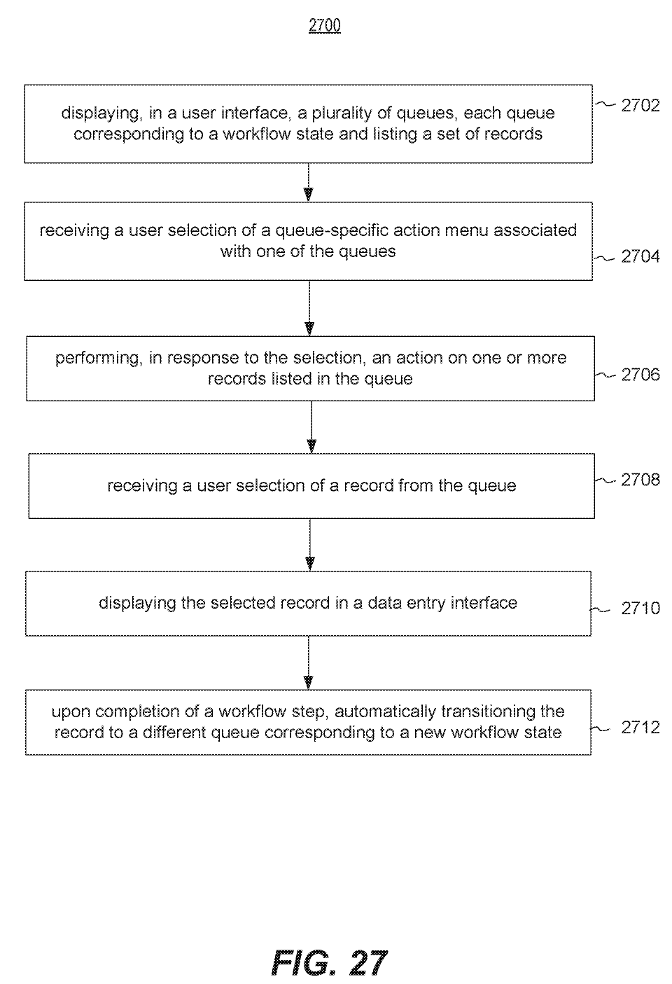

FIG. 27 illustrates an exemplary flowchart 2700 depicting operations associated with queue-centric record interaction and workflow progression in the disclosed records management system. Flowchart 2700 may operate independently or in conjunction with the processes described with respect to FIGS. 25 and 26, including process 2500 and process 2600. In some embodiments, flowchart 2700 may be executed as part of a user’s normal interaction with queues, while in other embodiments one or more steps may be performed automatically by the system in response to workflow events. As with other disclosed processes, steps of flowchart 2700 may be skipped, repeated, reordered, or executed concurrently depending on system configuration, record type, or user permissions.

At step 2702, the system may display, in a user interface, a plurality of queues, each queue corresponding to a workflow state and listing a set of records. Each queue may represent a logical grouping of records that share a common status, such as records awaiting review, records requiring additional input, or records that have completed a workflow step. The queues may be presented simultaneously within a single interface, allowing users to view and compare multiple workflow states at once. This arrangement may provide immediate visibility into the distribution of work across different stages of a process. In practical use, this step may allow a user to quickly identify which records require action and which records are pending further processing. For example, a supervisor may see records awaiting approval alongside records already approved, without navigating away from the main interface.

At step 2704, the system may receive a user selection of a queue-specific action menu associated with one of the queues. The queue-specific action menu may present actions applicable to the records listed in that queue, such as viewing details, filtering results, grouping records, exporting data, or deleting records. The selection may be received through a user interaction, such as selecting an icon or button associated with the queue header. In some embodiments, the available actions may vary based on the queue type, user role, or record status. This step may allow users to perform common operations directly within the context of a queue, reducing the need to open individual records or navigate to separate management screens. For instance, a user may export all records currently awaiting approval without opening each record individually.

At step 2706, the system may perform, in response to the user’s selection, an action on one or more records listed in the queue. The action may apply to a single selected record or to multiple records selected as a group, depending on the operation chosen. Performing the action may involve updating record attributes, generating output files, changing display properties of the queue, or initiating background processes. In some embodiments, the system may provide confirmation or feedback indicating that the action has been completed. This step may improve efficiency by allowing batch operations and reducing repetitive user interactions. For example, a user may apply a filter to narrow a large queue to only high-priority records, or may export a group of records for reporting or review purposes.

At step 2708, the system may receive a user selection of a record from the queue. The selection may identify a specific record using a unique identifier and may be initiated through a click, tap, or similar interaction. Upon receiving the selection, the system may retrieve the corresponding record data from the server and prepare it for display. In some embodiments, the system may also determine whether the record is editable based on workflow state or user permissions. This step may allow users to transition from a high-level, queue-based view of work to a focused view of an individual record. For example, after filtering a queue, a user may select a particular record that requires detailed review or modification.

At step 2710, the system may display the selected record in a data entry interface. The data entry interface may present structured sections and fields appropriate to the record type, enabling the user to view existing information and make updates as needed. In some embodiments, the interface may also display contextual information such as workflow status, validation indicators, or related records. The interface may be rendered within the same user environment as the queues, preserving continuity of interaction. This step provides a centralized workspace for record review and editing. For instance, a user may examine details of a report, add supplemental information, or correct errors identified during earlier workflow stages.

At step 2712, upon completion of a workflow step, the system may automatically transition the record to a different queue corresponding to a new workflow state. The transition may occur in response to user actions such as saving, submitting, approving, or rejecting the record. In some embodiments, the system may update metadata, record an audit entry, and refresh the displayed queues to reflect the new record location. This automatic transition may occur without requiring the user to manually move the record between queues. In certain implementations, this step may ensure that records are always presented in the appropriate queue as they progress through a workflow. For example, once a report is approved, it may immediately disappear from an “Approval” queue and appear in a “Completed” queue, providing clear and immediate feedback to users about workflow progression.

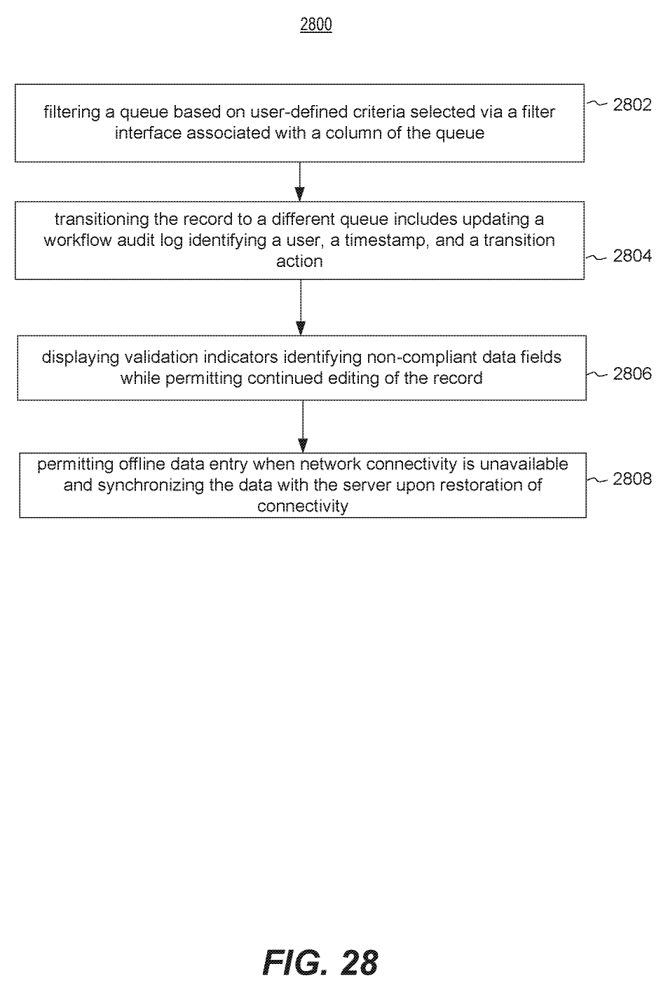

FIG. 28 illustrates an exemplary flowchart 2800 depicting additional operations that may enhance queue-based interaction, workflow tracking, and record editing in the disclosed records management system. Flowchart 2800 may operate in conjunction with, or as an extension of, process 2700 described with respect to FIG. 27, and may also be used alongside the processes described in FIGS. 25 and 26. In some embodiments, the steps of flowchart 2800 may be performed in response to user interaction, while in other embodiments one or more steps may be executed automatically by the system. As with other disclosed processes, the steps of flowchart 2800 may be skipped, repeated, performed out of order, or executed concurrently, depending on system configuration, workflow design, or record state.

At step 2802, the system may filter a queue based on user-defined criteria selected via a filter interface associated with a column of the queue. The filter interface may allow the user to specify one or more conditions, such as matching text, selecting values from a predefined list, or defining a date range. Upon receiving the selected criteria, the system may apply the filter to the queue by limiting the displayed records to those that satisfy the criteria. In some embodiments, filtering may be performed locally on already retrieved records, while in other embodiments the system may request a filtered result set from the server. This step may allow users to focus on a subset of records that are most relevant to their current task. For example, a user may filter an “In Progress” queue to show only records assigned to a particular location or priority level, reducing visual clutter and improving efficiency.

At step 2804, transitioning a record to a different queue may include updating a workflow audit log identifying a user, a timestamp, and a transition action. When a workflow transition occurs, the system may record contextual information describing who performed the action, when it occurred, and what type of transition was made. The audit log may be stored as part of the record metadata or in a separate audit data structure associated with the workflow. In some embodiments, the audit log may be accessible through a user interface that displays the history of workflow actions for the record. This step may provide transparency and accountability by preserving a traceable history of how a record moved through workflow states. In a real-world scenario, this may allow supervisors or auditors to review when a record was approved, rejected, or reassigned, and by whom.

At step 2806, the system may display validation indicators identifying non-compliant data fields while permitting continued editing of the record. The validation indicators may include visual cues such as icons, highlights, or messages adjacent to fields that do not satisfy predefined validation rules. Rather than blocking user interaction entirely, the system may allow the user to continue editing the record while clearly indicating which portions require correction. In some embodiments, validation indicators may update dynamically as the user modifies field values. This approach may help users resolve issues efficiently by providing immediate feedback without interrupting workflow. For example, a user editing a report may see which required fields are incomplete while still being able to add or revise other information.

At step 2808, the system may permit offline data entry when network connectivity is unavailable and synchronize the data with the server upon restoration of connectivity. While offline, the system may store entered data locally on the user’s device and may restrict access to certain features based on offline capabilities. When connectivity is restored, the system may automatically transmit locally stored updates to the server and reconcile any changes with server-side data. In some embodiments, the system may resolve conflicts or notify the user if discrepancies are detected. This step may allow users to continue working in environments with intermittent or unreliable network access. For instance, a user in the field may enter record information without an active connection and later synchronize the data when returning to a connected environment.

In some embodiments, the queue-specific action menu may provide bulk operations applicable to multiple selected records. A user may select multiple records within a queue and apply an action, such as exporting, deleting, or changing display attributes, to all selected records simultaneously. The system may process these bulk operations as a single request or as a series of coordinated operations, depending on implementation. Providing bulk operations may reduce repetitive actions and improve efficiency when managing large numbers of records.

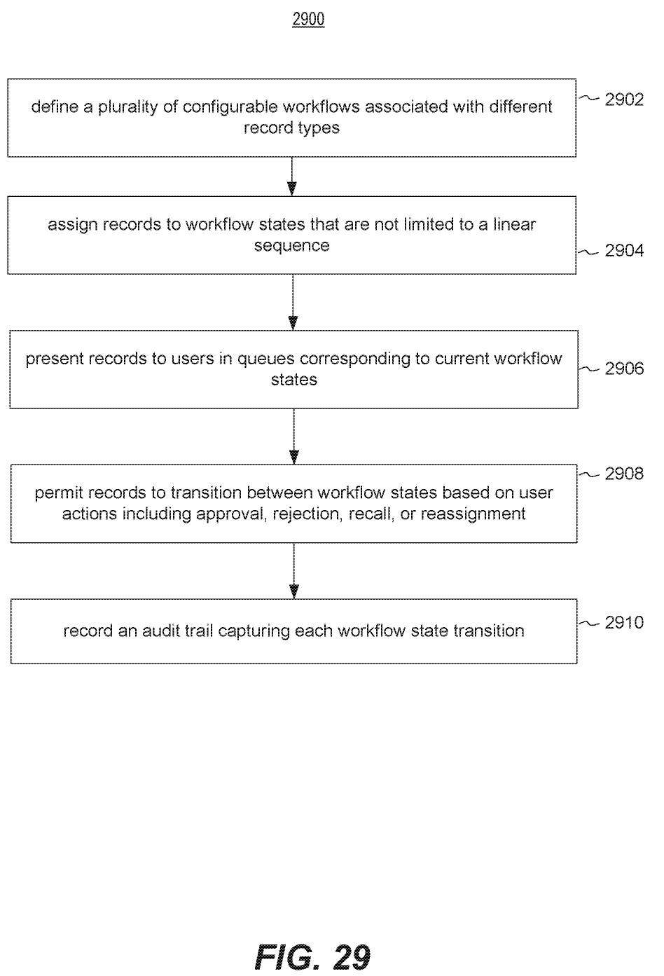

FIG. 29 illustrates an exemplary flowchart 2900 depicting operations related to configurable workflows and workflow-based record management in the disclosed system. Flowchart 2900 may operate in conjunction with the queue-centric processes described with respect to FIGS. 25–28, including processes 2500, 2600, 2700, and 2800. In some embodiments, flowchart 2900 may be invoked during system configuration, record creation, or record progression through a workflow, while in other embodiments one or more steps may be performed automatically in response to user actions. As with other disclosed processes, the steps of flowchart 2900 may be skipped, repeated, performed out of order, or executed concurrently depending on system configuration, workflow design, or record state.

At step 2902, the system may define a plurality of configurable workflows associated with different record types. Each workflow may specify a set of workflow states, transitions, and permitted actions that govern how records of a particular type progress through the system. In some embodiments, workflows may be created or modified using administrative configuration tools that allow authorized users to tailor workflows to organizational needs. The workflows may be stored as data structures that can be interpreted by the system at runtime to control record behavior. This step may allow different types of records—such as incident reports, case records, or field interviews—to follow workflows appropriate to their purpose. For example, one record type may require multiple review stages, while another may proceed directly to completion after submission.

At step 2904, the system may assign records to workflow states that are not limited to a linear sequence. Rather than forcing records to progress through a single fixed path, the system may support branching, looping, or conditional transitions between workflow states. The assignment of a record to a workflow state may be based on user actions, validation outcomes, or predefined rules. This flexibility may allow workflows to reflect real-world processes that do not always follow a strict linear order. In practical use, a record may move forward, backward, or laterally between states depending on circumstances. For instance, a record under review may be returned for additional input and later resubmitted without restarting the entire workflow.

At step 2906, the system may present records to users in queues corresponding to their current workflow states. Each queue may represent one workflow state and may list all records currently assigned to that state. The queues may be displayed within a unified user interface, enabling users to view and manage records based on status rather than by navigating through individual records. In some embodiments, the system may update the queues dynamically as records transition between workflow states. This step may provide clear visibility into the progression of work across an organization. For example, users may immediately see which records are awaiting action and which have already advanced to later stages.

At step 2908, the system may permit records to transition between workflow states based on user actions including approval, rejection, recall, or reassignment. These actions may be initiated from within a data entry interface, a queue-specific action menu, or another part of the user interface. Upon receiving a transition action, the system may evaluate whether the action is permitted based on the current workflow configuration and user permissions. If permitted, the system may update the record’s workflow state accordingly. This step may allow users to actively manage record progression without relying on rigid or automated transitions alone. For example, a supervisor may approve a record to advance it to a completed state or recall a previously submitted record for correction.

At step 2910, the system may record an audit trail capturing each workflow state transition. The audit trail may include information describing the transition event and may be stored as part of the record metadata or within a dedicated audit log. In some embodiments, the audit trail may be viewable through a user interface that presents a chronological history of workflow actions. The audit trail may persist even if a record is later modified or reassigned. This step may support accountability, traceability, and compliance by maintaining a historical record of how and when records moved through workflow states. For instance, the audit trail may allow administrators to review the sequence of approvals and rejections associated with a particular record.

In some embodiments, workflows may be configurable on a per-record-type or per-template basis. This may allow different templates of the same record type to follow distinct workflows, enabling further customization based on use case or jurisdictional requirements.

In some embodiments, the audit trail may identify, for each workflow transition, a user identifier, a time of transition, and a description of the action performed. Providing this level of detail may allow users and administrators to understand not only that a transition occurred, but also the context in which it occurred.

In some embodiments, records may bypass intermediate workflow states in response to a queue-level approval action. For example, a record may move directly from an initial review state to a completed state when expedited approval is authorized.

In some embodiments, the system may restrict access to records or workflow states based on user permission levels. Access controls may determine which users can view, edit, or transition records at particular workflow states, helping ensure that sensitive actions are performed only by authorized personnel.

Flowchart 2900 illustrates how configurable workflows, non-linear state transitions, and audit tracking may be combined to provide a flexible and transparent records management framework. When used together with the queue-centric processes described in FIGS. 25–28, these operations may enable organizations to tailor workflows to real-world processes while maintaining clear visibility and control over record progression.

In some embodiments, the disclosed records management system may be implemented using alternative technical architectures while achieving substantially the same functional results. For example, instead of a single centralized server, the system may be implemented using a distributed or cloud-based architecture in which record data, workflow logic, and user interface components are hosted across multiple computing resources. In such embodiments, queues and workflow states may be synchronized across devices using network messaging or event-driven updates, allowing multiple users to interact with the system concurrently while maintaining consistency. These alternative architectures may improve scalability, fault tolerance, or deployment flexibility without changing the core queue-centric interaction model.

In some embodiments, the disclosed system may be applied to industries and use cases beyond records management for law enforcement or public safety. For example, the system may be used in healthcare for managing patient records and approval workflows, in financial services for processing applications or compliance reviews, in human resources for onboarding and personnel records, or in logistics for tracking shipments and operational tasks. In each case, records may progress through queues corresponding to workflow states such as review, approval, exception handling, or completion. This flexibility may allow the same technical framework to be reused across diverse domains that require structured record handling and workflow visibility.

In some embodiments, additional features may be integrated with the disclosed system to further enhance user value. For example, the system may incorporate notification mechanisms that alert users when records enter or leave particular queues, when validation issues are detected, or when workflow deadlines approach. The system may also generate analytical metrics, such as workload distribution across queues or average time spent in each workflow state, to assist administrators in managing resources. These features may operate on top of the existing queue and workflow infrastructure, leveraging the same underlying data structures and audit information.

In some embodiments, certain elements of the disclosed system may be optional or selectively enabled based on deployment requirements or user roles. For example, offline data entry functionality may be enabled only for users operating in environments with intermittent connectivity, while other users may operate exclusively in an online mode. Similarly, validation rules or master record association features may be configured as mandatory in some deployments and optional in others. This configurability may allow organizations to balance strict data governance requirements with flexibility for different operational contexts.

In some embodiments, the queue-based user interface may be implemented using alternative presentation techniques while preserving the same functional behavior. For example, queues may be displayed as lists, cards, columns, tabs, or other visual groupings, and may be navigated using scrolling, pagination, or search-based filtering. The queue-specific action menus may be implemented as context menus, toolbar controls, or gesture-based interactions depending on device capabilities. These variations may allow the system to adapt to different screen sizes, accessibility requirements, or user preferences while maintaining the underlying queue-centric workflow logic.

In some embodiments, workflow configuration and enforcement may be extended using additional rule engines or external systems. For example, workflow transitions may be influenced by automated rules based on record content, external data sources, or time-based conditions. In other embodiments, the system may integrate with external systems, such as reporting databases, document management platforms, or analytics tools, to exchange data or trigger workflow events. These integrations may allow the disclosed system to operate as part of a larger enterprise ecosystem while retaining control over record state and workflow progression.

In some embodiments, the disclosed system may support additional security and access-control mechanisms beyond those explicitly described. For example, access to records, queues, or workflow actions may be restricted based on role-based permissions, organizational hierarchy, geographic location, or device type. The system may also support audit and compliance requirements by retaining historical versions of records, logging access attempts, or enforcing retention and expungement policies. These security-related features may be layered onto the queue-centric workflow model to meet regulatory or organizational requirements without altering core system behavior.

In some embodiments, records may appear in a particular queue based on one or more record attributes evaluated by the system. These attributes may include a workflow status, an assigned user or team, a role associated with the current user, or other conditions defined by system configuration. For example, records marked as “in progress” may appear in an In Progress queue, while records awaiting supervisory action may appear in an Approval queue. The system may evaluate these attributes dynamically so that queues reflect the current state of records without requiring manual sorting. In certain implementation, multiple conditions may be evaluated together to determine queue membership. For instance, a record may appear in a user’s personal queue only if it is assigned to that user and in a specific workflow state, while the same record may also appear in a department-level queue visible to supervisors. This approach may allow different users to see the same record in different queue contexts based on their responsibilities.

In some embodiments, when a record is updated, approved, or otherwise modified, the system may update queue membership and record visibility for other users automatically. These updates may occur immediately, near-real-time, or upon a subsequent interface refresh, depending on system configuration and connectivity. The system may propagate changes by refreshing queue contents, updating cached views, or re-evaluating queue conditions when users interact with the interface. In some implementations, users may see records move between queues automatically when workflow actions are completed. For example, when a supervisor approves a record, that record may disappear from the Approval queue and appear in a Completed queue without requiring manual intervention. In other implementations, users may see updated information upon refreshing the interface or returning to the queue view.

In some embodiments, different record types—such as incident records, case records, or field interview records—may be managed using a shared underlying interface and workflow framework. While each record type may include its own data fields, templates, or validation rules, the system may apply common logic for queue presentation, workflow progression, record editing, and audit tracking. This shared framework may simplify system maintenance and provide a consistent user experience across record types. In other embodiments, certain record types may include specialized behaviors or workflows layered on top of the shared framework. For example, an arrest record may require additional review steps compared to a field interview record, even though both are displayed and managed through the same queue-based interface. The system may accommodate these differences through configuration rather than separate implementations.

In some embodiments, users may perform a variety of actions directly from the queue view without opening individual records. These actions may include approving or rejecting records, assigning or reassigning records to other users or teams, exporting records for reporting purposes, or applying filters to narrow the displayed list. Queue-specific action menus may present only the actions relevant to the queue and the user’s permissions. In other embodiments, users may select a record from a queue to review details, make edits, or complete workflow steps within a data entry interface. The queue may serve as a starting point for both high-level management actions and detailed record interaction. In some cases, users may perform bulk actions on multiple selected records, such as exporting a set of reports or marking several items as reviewed.

In some embodiments, the system may be configurable to support different departments, agencies, or teams with distinct workflows, permissions, and operational needs. Configuration options may define which queues are visible, which actions are available, and how records move through workflow states for each group. These configurations may be applied without changing the underlying system code. For example, one agency may configure workflows that require multiple approval stages, while another agency may use a streamlined process with fewer steps. Similarly, permissions may be configured so that certain users can approve records, while others can only view or edit them. The system may enforce these differences consistently across queues and interfaces.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as iOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file system, networking, I/O services, and provide a user interface functionality, such as a graphical user interface (“GUI”), among other things.

Computer program products are also disclosed, comprising non-transitory computer-readable media storing instructions that, when executed by a processor, perform the steps of receiving data events, applying computational logic, executing models, generating outputs, and managing cached data. These instructions may be configured to operate within the described modular architecture and support asynchronous event processing.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals. It is intended, therefore, that the specification and examples be considered as example only, with a true scope and spirit being indicated by the following claims and their full scope of equivalents.

What is claimed:

1. A system for managing records, comprising:
a server comprising at least one processor and at least one memory storing instructions that, when executed, cause the server to:
display, in a browser-based user interface, a title bar persistent across a plurality of interface screens, a plurality of queues, each queue listing one or more records associated with a workflow status, and a slide-out menu providing access to record management functions;
receive a user selection of a record from one of the plurality of queues; display the selected record in a data entry interface; receive user input modifying one or more data fields of the record; and
save the modified record to the server while maintaining an association between the record and its workflow status.

2. The system of claim 1, wherein the slide-out menu includes selectable controls for accessing records, administrative functions, and configuration tools.

3. The system of claim 1, wherein each of the plurality of queues includes a queue-specific action menu enabling operations selected from viewing, filtering, grouping, exporting, or deleting records.

4. The system of claim 1, wherein the server is further configured to dynamically limit the number of records initially displayed in each queue and loading additional records in response to user scrolling.

5. The system of claim 1, further comprising dynamically modifying the data entry interface by enabling, disabling, or requiring data fields based on previously entered data.

6. The system of claim 5, further comprising preventing submission of the record to a subsequent workflow state until predefined validation rules are satisfied.

7. The system of claim 1, further comprising determining whether entered data corresponds to an existing master record and associating the record with the existing master record.

8. The system of claim 7, further comprising creating a new master record when no existing master record satisfies matching criteria.

9. The system of claim 1, wherein the user interface is accessible via a web browser executing on a mobile or desktop computing device.

10. A method of managing records using a computing system, comprising:
displaying, in a user interface, a plurality of queues, each queue corresponding to a workflow state and listing a set of records;
receiving a user selection of a queue-specific action menu associated with one of the queues;
performing, in response to the selection, an action on one or more records listed in the queue;
receiving a user selection of a record from the queue;
displaying the selected record in a data entry interface; and
upon completion of a workflow step, automatically transitioning the record to a different queue corresponding to a new workflow state.

11. The method of claim 10, wherein the queue-specific action menu provides bulk operations applicable to multiple selected records.

12. The method of claim 10, further comprising filtering a queue based on user-defined criteria selected via a filter interface associated with a column of the queue.

13. The method of claim 10, wherein transitioning the record to a different queue includes updating a workflow audit log identifying a user, a timestamp, and a transition action.

14. The method of claim 10, further comprising displaying validation indicators identifying non-compliant data fields while permitting continued editing of the record.

15. The method of claim 10, further comprising permitting offline data entry when network connectivity is unavailable and synchronizing the data with the server upon restoration of connectivity.

16. A records management system, comprising:
a processor and memory storing instructions that cause the system to:
define a plurality of configurable workflows associated with different record types;
assign records to workflow states that are not limited to a linear sequence;
present records to users in queues corresponding to current workflow states;
permit records to transition between workflow states based on user actions including approval, rejection, recall, or reassignment; and
record an audit trail capturing each workflow state transition.

17. The system of claim 16, wherein workflows are configurable on a per-record-type or per-template basis.

18. The system of claim 16, wherein the audit trail identifies, for each workflow transition, a user identifier, a time of transition, and a description of the action performed.

19. The system of claim 16, wherein records may bypass intermediate workflow states in response to a queue-level approval action.

20. The system of claim 16, further comprising restricting access to records or workflow states based on user permission levels.
